(19) United States
(12) Patent Application Publication
(10) Pub. No.: US 2013/0088619 A1
(43) Pub. Date: Apr. 11, 2013

(54) IMAGING APPARATUS, IMAGING SYSTEM, AND GAME APPARATUS

(71) Applicant: NINTENDO CO., LTD., Kyoto-shi (JP)

(72) Inventor: Takao SAWANO, Kyoto-shi (JP)

(73) Assignee: NINTENDO CO., LTD., Kyoto-shi (JP)

(21) Appl. No.: 13/688,434

(22) Filed: Nov. 29, 2012

Related U.S. Application Data
(63) Continuation of application No. 12/210,546, filed on Sep. 15, 2008.

(30) Foreign Application Priority Data
Jun. 30, 2008 (JP) 2008-171657

(51) Int. Cl. H04N 5/262

(52) U.S. Cl. CPC H04N 5/262
USPC 348/239

(57) ABSTRACT

An imaging apparatus comprises position information obtaining means, decoration image selection means, and composite image generation means. The position information obtaining means obtains position information indicative of a position where the imaging apparatus is present. The decoration image selection means selects a predetermined decoration image from predetermined storage means based on the position information. The composite image generation means composites the predetermined decoration image selected by the decoration image selection means and a taken image to generate a composite image.

### CROSS REFERENCE TO RELATED APPLICATIONS

This application is a continuation of U.S. Ser. No. 12/210,546, filed Sep. 15, 2008, which claims the benefit of Japanese Patent Application No. 2008-171657, filed on Jun. 30, 2008, each of which is incorporated herein in its entirety.

### BACKGROUND AND SUMMARY

1. Technical Field

The technology presented herein relates to an imaging apparatus, an imaging system, and a game apparatus, and more particularly, to an imaging apparatus, an imaging system, and a game apparatus for performing imaging after compositing predetermined image data and an imaging object such as a view, a person, and the like.

2. Description of the Background Art

Conventionally, there has been known a still image imaging apparatus which composites photograph frame data stored in advance in a main memory with respect to data of a still image taken by imaging means, and stores a composite image in the main memory (e.g. Japanese Patent Laid-open Publication No. 11-146315).

However, the still image imaging apparatus disclosed in Japanese Patent Laid-open Publication No. 11-146315 has the following problem. In such an imaging apparatus, photograph frame data which is to be composited to data of a still image taken by imaging means is selected among data stored in advance in a main memory. Thus, since photograph frame data can be used anytime and anywhere, a value cannot be added to each photograph frame data, and new enjoyment, surprise, and the like cannot be provided to a user.

### SUMMARY OF THE INVENTION

Therefore, a feature of the example embodiments presented herein are to provide an imaging apparatus, an imaging system, and a game apparatus for adding a value to photograph frame data which is to be composited to data of a still image taken by imaging means to provide new enjoyment to a user.

The present embodiments have the following features to attain the above. It is noted that reference characters and supplementary explanations in parentheses in this section are merely provided to facilitate the understanding of the present embodiment in relation to the later-described embodiment, rather than limiting the scope of the present embodiment in any way.

A first aspect of the present embodiment is directed to an imaging apparatus (101) for compositing a taken image taken by imaging means (25) and a decoration image stored in storage means (32) to generate a composite image. The imaging apparatus comprises position information obtaining means (31), decoration image selection means (31), and composite image generation means (31). The position information obtaining means is means for obtaining position information indicative of a position where the imaging apparatus is present. The decoration image selection means is means for selecting a predetermined decoration image from the storage means based on the position information. The composite image generation means is means for compositing the predetermined decoration image selected by the decoration image selection means and the taken image to generate a composite image.

According to the first aspect, a value is added to a decoration image which is to be composited to a taken image, and new enjoyment can be provided to a user.

In a second aspect, the imaging apparatus further comprises wireless communication means (37) for performing wireless communication. The position information obtaining means includes identification information obtaining means for obtaining identification information of a wireless communication relay point which is present in a communicable range of the wireless communication means. The decoration image selection means selects a predetermined decoration image from the storage means based on the identification information obtained by the identification information obtaining means.

According to the second aspect, it is possible to easily identify a position using wireless communication.

In a third aspect, when there are a plurality of wireless communication relay points which are present in the communicable range of the wireless communication means, the identification information obtaining means obtains identification information of a wireless communication relay point having the largest radio wave intensity.

According to the third aspect, it is possible to more accurately identify a position by detecting radio wave intensity.

In a fourth aspect, the position information obtaining means includes position information measuring means for measuring position information of the imaging apparatus. The decoration image selection means selects a predetermined decoration image from the storage means based on the position information measured by the position information measuring means.

According to the fourth aspect, it is possible for the imaging apparatus to measure a position of the imaging apparatus, thereby enabling more accurate position measurement.

In a fifth aspect, the imaging apparatus further comprises date and time information obtaining means (31, 39) for obtaining date and time information regarding a current date and time. The decoration image selection means selects a predetermined decoration image from the storage means based on the position information and the date and time information obtained by the date and time information obtaining means.

According to the fifth aspect, since a decoration image is selected using the date and time information in addition to the position information, the added value of the decoration image can be enhanced more.

In a sixth aspect, the imaging apparatus further comprises decoration image update means for adding, updating, or deleting the decoration image via at least one of a predetermined communication line and an external storage unit which is connectable to the imaging apparatus.

According to the sixth aspect, it is possible to update a content of the decoration image, and thus variations of decoration images can be increased in advance.

In a seventh aspect, the imaging apparatus further comprises display means for displaying at least one of the taken image, the decoration image, and the composite image.

According to the seventh aspect, the user can visually confirm a taken image, a decoration image, or a composite image obtained by compositing the taken image and the decoration image.

In an eighth aspect, the imaging apparatus further comprises: operation input means (13, 14) for accepting a predetermined operation input; and decoration image editing means (31) for performing editing of the decoration image displayed on the display means or a decoration image on the composite image based on the operation input accepted by the operation input means.

According to the eighth aspect, an opportunity for editing of a composite image is provided to the user, and it is possible to generate a composite image desired by the user.

In a ninth aspect, the operation input means is a pointing device. The decoration image editing means performs editing by means of the pointing device.

In a tenth aspect, the pointing device is a touch panel. The touch panel is located on the display means so as to cover the display means. The decoration image editing means performs editing of the decoration image displayed on the display means or a decoration image on the composite image based on an input by a user with respect to the touch panel.

According to the ninth and tenth aspects, regarding an editing operation, intuitive operability can be provided to the user.

In an eleventh aspect, the decoration image selection means selects a plurality of decoration images. The imaging apparatus further comprises user selection means for causing a user to select a desired image among the plurality of decoration images selected by the decoration image selection means.

According to the eleventh aspect, a plurality of decoration images are displayed to the user, and the user can be caused to select a desired decoration image, thereby providing greater enjoyment of photographing.

A twelfth aspect of the present embodiment is directed to an imaging system comprising a server (103) for storing a decoration image in storage means, and an imaging apparatus (101) for compositing a taken image taken by imaging means and a predetermined decoration image to generate a composite image. The server is connected to the imaging apparatus via a network. The imaging apparatus comprises position information obtaining means (31), position information transmission means (31, 37), decoration image reception means (31, 37), and composite image generation means (31). The server comprises position information reception means (61, 63), decoration image selection means (61), and decoration image transmission means (61, 63). The position information obtaining means is means for obtaining position information indicative of a position where the imaging apparatus is present. The position information transmission means is means for transmitting the position information to the server. The decoration image reception means is means for receiving a predetermined decoration image from the server. The composite image generation means is means for compositing the predetermined decoration image received by the decoration image reception means and the taken image to generate a composite image. The position information reception means is means for receiving the position information from the imaging apparatus. The decoration image selection means is means for selecting a predetermined decoration image from the storage means of the server using the position information received by the position information reception means. The decoration image transmission means is means for transmitting the predetermined decoration image selected by the decoration image selection means to the imaging apparatus.

According to the twelfth aspect, a decoration image which is different depending on a position where the imaging apparatus is present can be provided to the imaging apparatus, thereby adding a value to a decoration image and providing new enjoyment to the user.

In a thirteenth aspect, the imaging apparatus further comprises wireless communication means for performing wireless communication. The position information obtaining means includes identification information obtaining means for obtaining identification information of a wireless communication relay point which is present in a communicable range of the wireless communication means. The position information transmission means transmits the identification information obtained by the identification information obtaining means as the position information to the server.

According to the thirteenth aspect, it is possible to easily identify a position using the identification information of the wireless communication relay point.

In a fourteenth aspect, the wireless communication relay point is present within the network, and the position information transmission means, the decoration image reception means, the position information reception means, and the decoration image transmission means each perform transmission or reception via the wireless communication relay point within the network.

According to the fourteenth aspect, by performing transmission and reception of the identification information via the wireless communication relay point, a number of wireless communication relay points to be used can be reduced.

In a fifteenth aspect, when there are a plurality of wireless communication relay points which are present in the communicable range of the wireless communication means, the identification information obtaining means obtains identification information of a wireless communication relay point having the largest radio wave intensity.

According to the fifteenth aspect, it is possible to obtain more accurate position information.

In a sixteenth aspect, the position information obtaining means includes position information measuring means for measuring position information of the imaging apparatus. The position information transmission means transmits the position information measured by the position information measuring means.

According to the sixteenth aspect, it is possible for the imaging apparatus to measure a position of the imaging apparatus, thereby enabling more accurate position measurement.

In a seventeenth aspect, the imaging apparatus further comprises: date and time information obtaining means (31, 39) for obtaining date and time information regarding a current date and time; and date and time information transmission means for transmitting the date and time information to the server. The server further comprises: date and time information reception means (63) for receiving the date and time information from the imaging apparatus. The decoration image selection means selects a predetermined decoration image from the storage means of the server based on the position information and the date and time information received by the date and time information reception means.

According to the seventeenth aspect, since a decoration image is selected using the date and time information in addition to the position information, the added value of the decoration image can be enhanced more.

An eighteenth aspect of the present embodiment is directed to an imaging system comprising a server (103) for storing a decoration image in storage means, a relay apparatus (104) which is connected to the server via a network, and a imaging apparatus (101) which is connected to the relay apparatus for compositing a taken image taken by imaging means and a predetermined decoration image to generate a composite image. The relay apparatus comprises position information obtaining means (31), first position information transmission means (31, 37), first decoration image reception means (31, 37), and first decoration image transmission means (31, 38). The imaging apparatus comprises second decoration image reception means (38), and composite image generation means (31). The server comprises first position information reception means (63), decoration image selection means (61), and second decoration image transmission means (63). The position information obtaining means is means for obtaining position information indicative of a position where the relay apparatus is present. The first position information transmission means is means for transmitting the position information to the server. The first decoration image reception means is means for receiving a predetermined decoration image from the server. The first decoration image transmission means is means for transmitting the decoration image received by the first decoration image reception means to the imaging apparatus. The second decoration image reception means is means for receiving the predetermined decoration image from the relay apparatus. The composite image generation means is means for compositing the predetermined decoration image received by the second decoration image reception means and the taken image to generate a composite image. The first position information reception means is means for receiving the position information from the relay apparatus. The decoration image selection means is means for selecting a predetermined decoration image from the storage means of the server using the position information received by the first position information reception means. The second decoration image transmission means is means for transmitting the predetermined decoration image selected by the decoration image selection means to the relay apparatus.

According to the eighteenth aspect, a value is added to a decoration image which is to be composited to a taken image, and new enjoyment can be provided to the user.

In a nineteenth aspect, the relay apparatus further comprises wireless communication means (37) for performing wireless communication. The position information obtaining means includes identification information obtaining means (31) for obtaining identification information of a wireless communication relay point which is present in a communicable range of the wireless communication means. The position information transmission means transmits the identification information obtained by the identification information obtaining means as the position information to the server.

According to the nineteenth aspect, it is possible to easily identify a position using wireless communication.

In a twentieth aspect, the wireless communication relay point is present within the network, and the first position information transmission means, the first decoration image reception means, the first position information reception means, and the second decoration image transmission means each perform transmission or reception via the wireless communication relay point within the network.

According to the twentieth aspect, by performing transmission and reception of the identification information via the obtained wireless communication relay point, a number of wireless communication relay points to be used can be reduced.

In a twenty-first aspect, when there are a plurality of wireless communication relay points which are present in the communicable range of the wireless communication means, the identification information obtaining means obtains identification information of a wireless communication relay point having the largest radio wave intensity.

According to the twenty-first aspect, it is possible to obtain more accurate position information.

In a twenty-second aspect, the position information obtaining means includes position information measuring means for measuring position information of the relay apparatus. The position information transmission means transmits the position information measured by the position information measuring means.

According to the twenty-second aspect, it is possible for the relay apparatus to measure a position of the relay apparatus, thereby enabling more accurate position measurement.

In a twenty-third aspect, the imaging apparatus further comprises: position information measuring means for measuring position information of the imaging apparatus; and second position information transmission means for transmitting the position information to the relay apparatus. The relay apparatus further comprises second position information reception means for receiving the position information from the imaging apparatus. The first position information transmission means transmits the position information received by the second position information reception means.

According to the twenty-third aspect, it is possible for the imaging apparatus to measure a position of the imaging apparatus, thereby enabling more accurate position measurement.

In a twenty-fourth aspect, the imaging apparatus further comprises date and time information obtaining means and first date and time information transmission means. The date and time information obtaining means is means for obtaining date and time information regarding a current date and time. The first date and time information transmission means is means for transmitting the date and time information to the relay apparatus. The relay apparatus further comprises first date and time information reception means and second date and time information transmission means. The first date and time information reception means is means for receiving the date and time information from the imaging apparatus. The second date and time information transmission means is means for transmitting the date and time information received from the imaging apparatus to the server. The server further comprises second date and time information reception means. The second date and time information reception means is means for receiving the date and time information from the relay apparatus. The decoration image selection means selects a predetermined decoration image from the storage means of the server based on the position information and the date and time information received by the second date and time information reception means.

In a twenty-fifth aspect, the relay apparatus further comprises: date and time information obtaining means for obtaining date and time information regarding a current date and time; and date and time information transmission means for transmitting the date and time information to the server. The server further comprises: date and time information reception means for receiving the date and time information from the relay apparatus. The decoration image selection means selects a predetermined decoration image from the storage means of the server based on the position information and the date and time information received by the date and time information reception means.

According to the twenty-fourth and twenty-fifth aspects, since a decoration image is selected using the date and time information in addition to the position information, the added value of the decoration image can be enhanced more.

In a twenty-sixth aspect, the server further comprises date and time information obtaining means for obtaining date and time information regarding a current date and time. The decoration image selection means selects a predetermined decoration image from the storage means of the server based on the position information and the date and time information obtained by the date and time information obtaining means.

In a twenty-seventh aspect, the server further comprises date and time information obtaining means for obtaining date and time information regarding a current date and time. The decoration image selection means selects a predetermined decoration image from the storage means of the server based on the position information and the date and time information obtained by the date and time information obtaining means.

According to the twenty-sixth and twenty-seventh aspects, since a decoration image is selected using the date and time information in addition to the position information, the added value of the decoration image can be enhanced more. In addition, since the date and time information of the server is used, even when the user sets an inaccurate date and time in the imaging apparatus, a decoration image can be appropriately selected without having the influence.

In a twenty-eighth aspect, the imaging apparatus further comprises display means for displaying at least one of the taken image, the decoration image, and the composite image.

According to the twenty-eighth aspect, the user can visually confirm a taken image, a decoration image, or a composite image obtained by compositing the taken image and the decoration image.

In a twenty-ninth aspect, the imaging apparatus further comprises: operation input means for accepting a predetermined operation input; and decoration image editing means for performing editing of the decoration image displayed on the display means or a decoration image on the composite image based on the operation input accepted by the operation input means.

According to the twenty-ninth aspect, an opportunity for editing of a composite image is provided to the user, and it is possible to generate a composite image desired by the user.

In a thirtieth aspect, the operation input means is a pointing device. The decoration image editing means performs editing by means of the pointing device.

In a thirty-first aspect, the pointing device is a touch panel. The touch panel is located on the display means so as to cover the display means. The decoration image editing means performs editing of the decoration image displayed on the display means or a decoration image on the composite image based on an input by a user with respect to the touch panel.

According to the thirtieth and thirty-first aspects, regarding an editing operation, intuitive operability can be provided to the user.

In a thirty-second aspect, the imaging apparatus further comprises display means for displaying at least one of the taken image, the decoration image, and the composite image.

According to the thirty-second aspect, the user can visually confirm a taken image, a decoration image, or a composite image obtained by compositing the taken image and the decoration image.

In a thirty-third aspect, the imaging apparatus further comprises: operation input means for accepting a predetermined operation input; and decoration image editing means for performing editing of the decoration image displayed on the display means or a decoration image on the composite image based on the operation input accepted by the operation input means.

According to the thirty-third aspect, an opportunity for editing of a composite image is provided to the user, and it is possible to generate a composite image desired by the user.

In a thirty-fourth aspect, the operation input means is a pointing device. The decoration image editing means performs editing by means of the pointing device.

In a thirty-fifth aspect, the pointing device is a touch panel. The touch panel is located on the display means so as to cover the display means. The decoration image editing means performs editing of the decoration image displayed on the display means or a decoration image on the composite image based on an input by a user with respect to the touch panel.

According to the thirty-fourth and thirty-fifth aspects, regarding an editing operation, intuitive operability can be provided to the user.

In a thirty-sixth aspect, the imaging apparatus further comprises decoration image deletion means (31) for deleting the decoration image received by the imaging apparatus at a predetermined timing.

In a thirty-seventh aspect, the predetermined timing is a timing at which a power of the imaging apparatus is turned off.

In a thirty-eighth aspect, the imaging apparatus further comprises composite image storing means (31) for storing the composite image in a predetermined storage medium. The predetermined timing is a timing at which the composite image storing means stores the composite image.

According to the thirty-sixth to thirty-eighth aspects, the added value of the decoration image can be enhanced more.

In a thirty-ninth aspect, the imaging apparatus further comprises decoration image deletion means (31) for deleting the decoration image received by the imaging apparatus at a predetermined timing.

In a fortieth aspect, the predetermined timing is a timing at which a power of the imaging apparatus is turned off.

In a forty-first aspect, the imaging apparatus further comprises composite image storing means (31) for storing the composite image in a predetermined storage medium. The predetermined timing is a timing at which the composite image storing means stores the composite image.

According to the thirty-ninth to forty-first aspects, the added value of the decoration image can be enhanced more.

In a forty-second aspect, the decoration image selection means selects a plurality of decoration images. The imaging apparatus further comprises user selection means for causing a user to select a desired image among the plurality of decoration images selected by the decoration image selection means.

In a forty-third aspect, the decoration image selection means selects a plurality of decoration images. The imaging apparatus further comprises user selection means for causing a user to select a desired image among the plurality of decoration images selected by the decoration image selection means.

According to the forty-first and forty-second aspects, a plurality of decoration images are displayed to the user, and the user can be caused to select a desired decoration image, thereby providing greater enjoyment of photographing.

A forty-fourth aspect of the present embodiment is directed to a game apparatus for compositing a taken image taken by imaging means (25) and a decoration image stored in storage means (32) to generate a composite image. The game apparatus comprises position information obtaining means (31), decoration image selection means (31), and composite image generation means (31). The position information obtaining means is means for obtaining position information indicative of a position where the game apparatus is present. The decoration image selection means is means for selecting a predetermined decoration image from the storage means using the position information. The composite image generation means is means for compositing the predetermined decoration image selected by the decoration image selection means and the taken image to generate a composite image.

According to the forty-fourth aspect, the same advantageous effect as the first aspect is obtained.

A forty-fifth aspect of the present embodiment is directed to an imaging system comprising a server (103) for storing a decoration image in storage means, and a game apparatus (101) for compositing a taken image taken by imaging means and a predetermined decoration image to generate a composite image. The server is connected to the game apparatus via a network. The game apparatus comprises position information obtaining means (31), position information transmission means (31, 37), decoration image reception means (31, 37), and composite image generation means (31). The server comprises position information reception means (61, 63), decoration image selection means (61), and decoration image transmission means (61, 63). The position information obtaining means is means for obtaining position information indicative of a position where the game apparatus is present. The position information transmission means is means for transmitting the position information to the server. The decoration image reception means is means for receiving a predetermined decoration image from the server. The composite image generation means is means for compositing the predetermined decoration image received by the decoration image reception means and the taken image to generate a composite image. The position information reception means is means for receiving the position information from the game apparatus. The decoration image selection means is means for selecting a predetermined decoration image from the storage means of the server based on the position information received by the position information reception means. The decoration image transmission means is means for transmitting the predetermined decoration image selected by the decoration image selection means to the game apparatus.

According to the forty-fifth aspect, a decoration image which is different depending on a position where the imaging apparatus is present can be provided to the imaging apparatus, thereby adding a value to a decoration image and providing new enjoyment to the user.

A forty-sixth aspect of the present embodiment is directed to an imaging system comprising a server (103) for storing a decoration image in storage means, a relay apparatus (104) which is connected to the server via a network, and a game apparatus (101) which is connected to the relay apparatus for compositing a taken image taken by imaging means and a predetermined decoration image to generate a composite image. The relay apparatus comprises position information obtaining means (31), first position information transmission means (31, 37), first decoration image reception means (31, 37), and first decoration image transmission means (31, 38). The game apparatus comprises second decoration image reception means (38), and composite image generation means (31). The server comprises first position information reception means (63), decoration image selection means (61), and second decoration image transmission means (63). The position information obtaining means is means for obtaining position information which is information on where the relay apparatus is located. The first position information transmission means is means for transmitting the position information to the server. The first decoration image reception means is means for receiving a predetermined decoration image from the server. The first decoration image transmission means is means for transmitting the predetermined decoration image received by the first decoration image reception means to the game apparatus. The second decoration image reception means is means for receiving the predetermined decoration image from the relay apparatus. The composite image generation means is means for compositing the predetermined decoration image received by the second decoration image reception means and the taken image to generate a composite image. The first position information reception means is means for receiving the position information from the relay apparatus. The decoration image selection means is means for selecting a predetermined decoration image from the storage means of the server based on the position information received by the position information reception means. The second decoration image transmission means is means for transmitting the predetermined decoration image selected by the decoration image selection means to the relay apparatus.

According to the forty-sixth aspect, the same advantageous effect as the first aspect is obtained.

According to the present embodiment, a value is added to a decoration image which is to be composited to a taken image, and new enjoyment can be provided to the user.

These and other features, aspects and advantages of the present embodiment will become more apparent from the following detailed description of the present embodiment when taken in conjunction with the accompanying drawings.

### BRIEF DESCRIPTION OF THE DRAWINGS

FIG. 1 is a view showing an example of a composite image according to a first embodiment;

FIG. 2 is a view of a network configuration according to the first embodiment;

FIG. 3 is a view for explaining an outline of processing according to the first embodiment;

FIG. 4 is a view showing an example of an event site;

FIG. 5 is an external view of a game apparatus 101 for executing imaging processing program according to the first embodiment;

FIG. 6 is a block diagram showing an example of an internal configuration of the game apparatus 101 in FIG. 5;

FIG. 7 is a functional block diagram showing a configuration of a server 103 according to the first embodiment;

FIG. 8 is a view showing a memory map of a main memory 62 of the server 103 shown in FIG. 7;

FIG. 9 is a view showing an example of an AP-image correspondence table 625;

FIG. 10 is a view showing a memory map of a main memory 32 of the game apparatus 101;

FIG. 11 is a flow chart showing in detail imaging processing executed by the game apparatus 101;

FIG. 12 is a flow chart showing in detail communication processing executed by the server 103;

FIG. 13 is a flow chart showing in detail decoration image data load processing shown at a step S34 in FIG. 12;

FIG. 14 is a view showing a network configuration according to a second embodiment;

FIG. 15 is a view for explaining an outline of processing according to the second embodiment;

FIG. 16 is a flow chart showing in detail processing executed by a relay apparatus 104;

FIG. 17 is a flow chart showing in detail processing executed by a slave apparatus 101;

FIG. 18 is a view showing an example of a correspondence table when position information such as latitude, longitude, and the like is used;

FIG. 19 is a view for explaining an outline of processing according to a third embodiment;

FIG. 20 is a flow chart showing in detail processing of a game apparatus 101 according to the third embodiment;

FIG. 21 is a view showing a memory map of a main memory of a game apparatus 101 according to a fourth embodiment;

FIG. 22 is a view for explaining an outline of processing according to the fourth embodiment;

FIG. 23 is a flow chart showing in detail processing of the game apparatus 101 according to the fourth embodiment;

FIG. 24 is a view for explaining an outline of processing according to a fifth embodiment; and

FIG. 25 is a flow chart showing in detail processing of a game apparatus 101 according to the fifth embodiment.

### DESCRIPTION OF THE PREFERRED EMBODIMENTS

The following will describe embodiments of the present technology with reference to the drawings. The present technology is not limited by the embodiments.

### First Embodiment

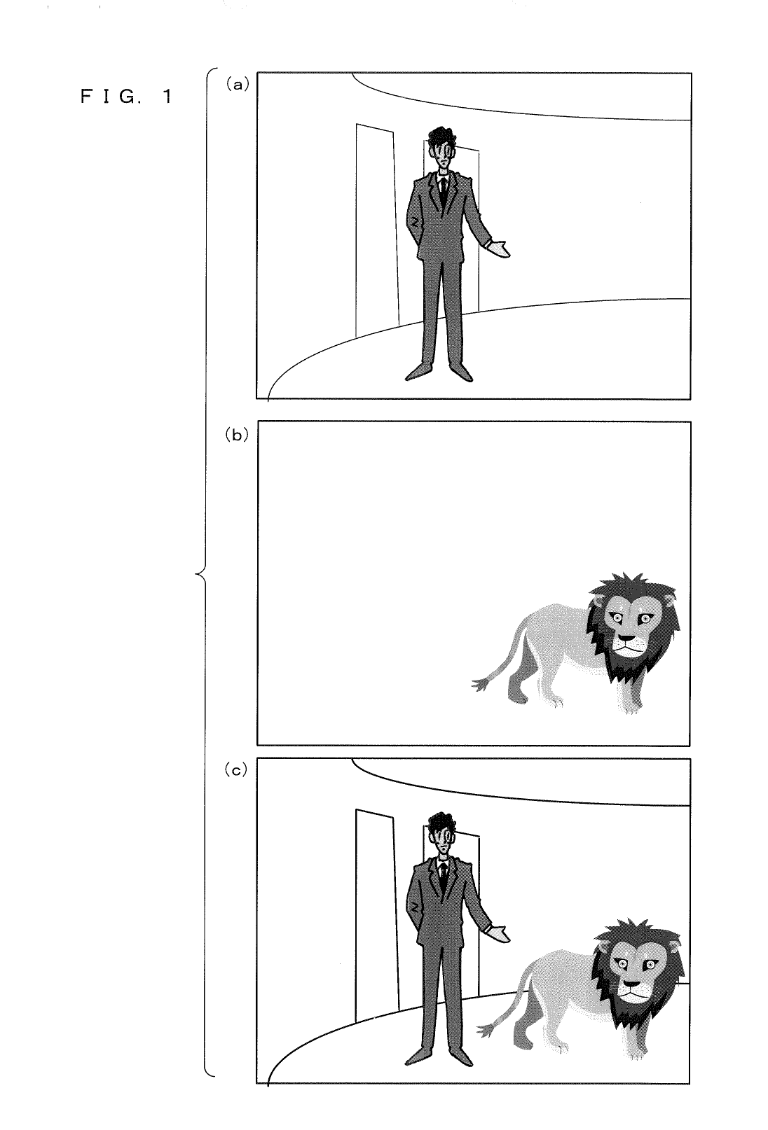

An outline of processing assumed in the first embodiment will be described. In the present embodiment, processing of compositing a predetermined image (hereafter, referred to as a decoration image) and a camera image taken by a hand-held game apparatus (hereinafter, referred to merely as a game apparatus) having a camera to generate a composite photograph (composite image) is assumed. For example, this processing is processing of, when an image of a view shown in FIG. 1(a) is taken by a camera, compositing a decoration image, for compositing, shown in FIG. 1(b) and the taken image of the view to generate a composite image (composite photograph) shown in FIG. 1(c). The decoration image is not limited to an image of a character as shown in FIG. 1(b), and may be an image like a photograph frame, or may be an image other than a character, such as a building, and the like.

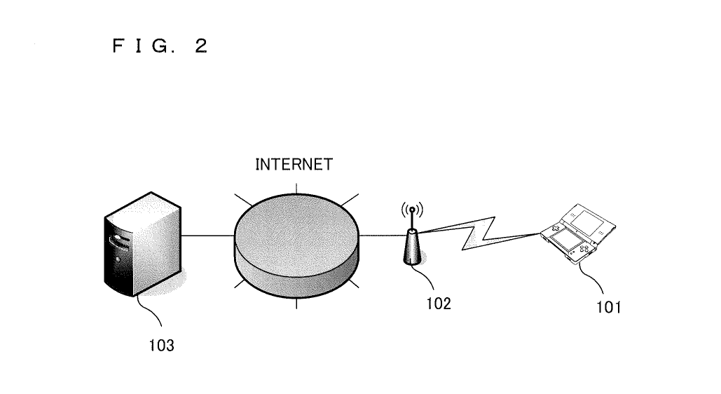

In the present embodiment, data of the above decoration image is obtained from a later-described predetermined server. The game apparatus performs communication with the server via the Internet. Further, in the present embodiment, the game apparatus uses wireless communication when connecting to the Internet. More specifically, the game apparatus connects to the Internet, further to a server, via a wireless communication relay point which is a radio wave relay apparatus for connecting between a terminal and a server in wireless communication. In the present embodiment, the game apparatus performs communication with an access point (hereinafter, referred to as AP), which is the above wireless communication relay point, using a wireless LAN device, and connects to the Internet via the AP. FIG. 2 shows a network configuration according to the present embodiment. As shown in FIG. 2, a game apparatus 101 performs communication with a server 103 via an AP 102 and the Internet. The game apparatus 101 obtains the above decoration image from the server 103, and in the present embodiment, a content of a decoration image transmitted from the server 103 is different depending on a position where the game apparatus 101 connecting to the server 103 is present. More specifically, in the server 103, identification information of the AP 102 (e.g. an SSID (Service Set Identifier)) is associated in advance with data of a decoration image (in other words, the above predetermined AP 102 is an AP which has already been registered to the server 103). When the game apparatus 101 requests data of a decoration image from the server 103, the game apparatus 101 transmits to the server 103 the identification information of the AP 102 which is connected to the game apparatus 101. Accordingly, the server 103 executes processing of selecting data of a decoration image corresponding to the identification information and transmitting the data to the game apparatus 101. In other words, the game apparatus 101 receives from the server 103 data of a decoration image which is different depending on an AP 102 to which the game apparatus 101 has established connection. Generally, APs 102 are placed in a plurality of regions and places. Due to nature that a communicable range (a radio wave range) of a wireless LAN device is generally small, the AP 102 to which the game apparatus 101 has established connection is naturally located close to the game apparatus 101, and a position where the AP 102 is present substantially can indicate a position where the game apparatus 101 is present. In other words, the identification information of the AP 102 can be position information of the game apparatus 101. As a result, depending on a “position” where the game apparatus 101 establishes connection to the server 103, it is possible to obtain data of a different decoration image.

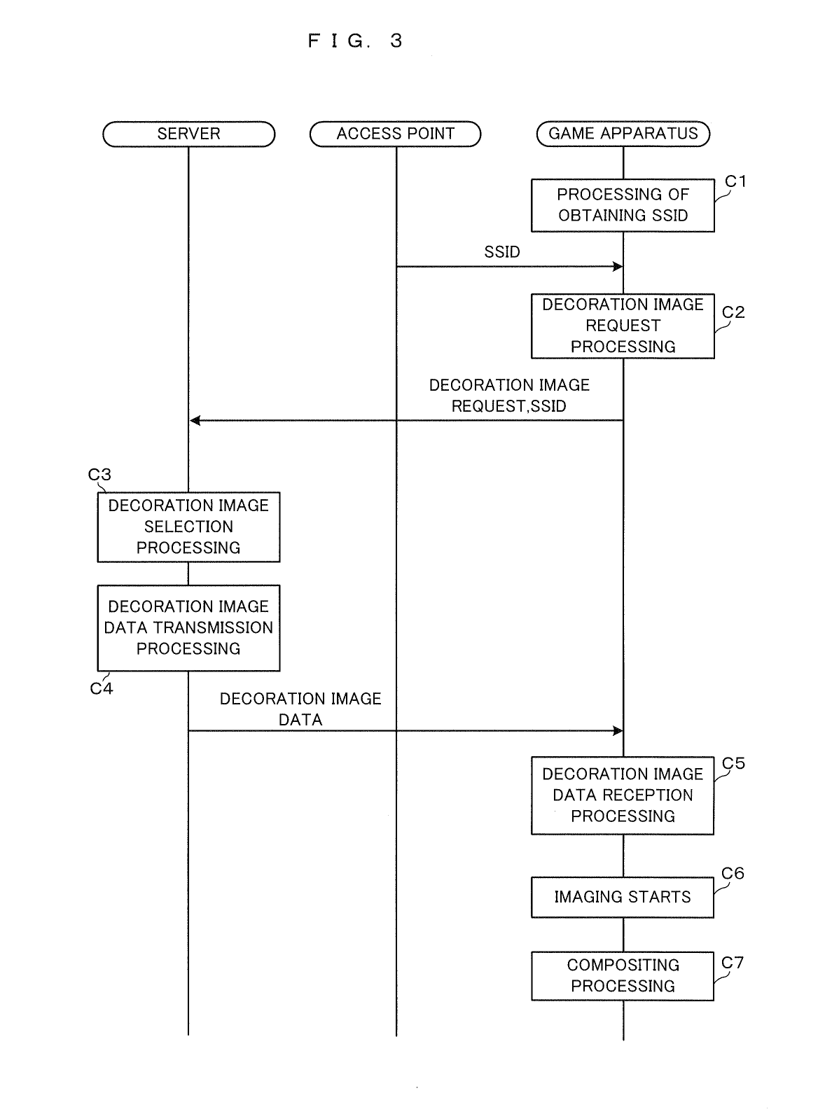

The following will describe an outline of processing according to the first embodiment with reference to FIG. 3. FIG. 3 is a sequence chart for explaining the outline of the processing according to the first embodiment. As shown in FIG. 3, the game apparatus 101 obtains an SSID from an AP 102, and executes processing of establishing connection to the AP 102 (C1).

Next, the game apparatus 101 establishes connection to a predetermined server 103 via the AP 102 and the Internet, and then executes processing of requesting data of a decoration image from the server 103 (C2). At this time, the game apparatus 101 transmits the SSID obtained from the AP 102 to the server 103.

The server 103 executes processing of selecting a decoration image (e.g. an image as shown in FIG. 1(b)) based on the SSID transmitted from the game apparatus 101 (C3). Then, the server 103 executes processing of transmitting data of the selected decoration image to the game apparatus 101 (C4).

The game apparatus 101 executes processing of receiving the data of the decoration image which is transmitted from the server 103 (C5). Then, the game apparatus 101 activates a camera to start imaging processing (C6), and executes compositing processing of compositing the received decoration image and a camera image (a view captured by the camera) (C7). As a result, a composite image as shown in FIG. 1(c) is displayed on a monitor of the game apparatus 101, and stored in a predetermined storage medium by a user pressing a shutter button.

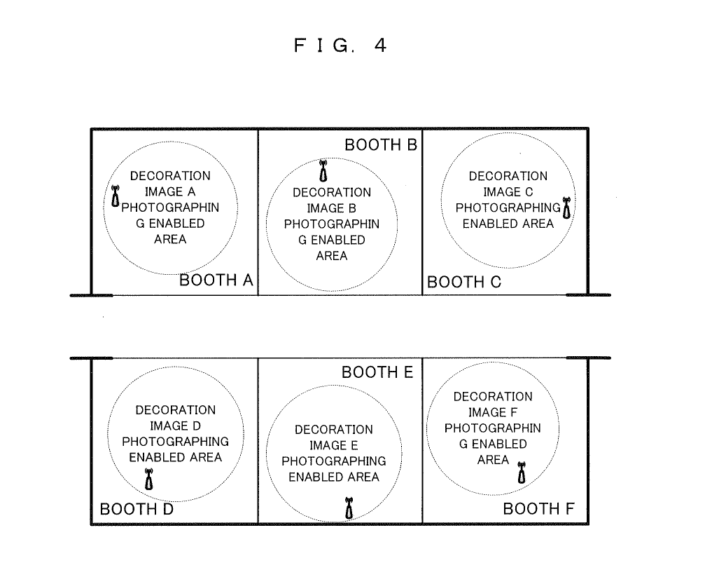

As described above, in the present embodiment, a decoration image is prepared in a server for each AP 102, and a different decoration image is transmitted depending on an AP 102 used by the game apparatus 101 which has been connected to the server 103. Thus, a composite image including a decoration image which is different depending on a position where the game apparatus 101 accesses the server 103 can be generated. For example, as shown in FIG. 4, in an event site in which there are six booths (boots A to F), a different AP 102 is placed in each booth. A different decoration image is registered to the server 103 so as to be associated with each AP 102. A visitor communicates with an AP 102 placed in a booth, and obtains a decoration image from the server 103. Thus, it is possible to take a composite photograph including a decoration image which is different for each booth of the event site. In other words, by limiting acquisition of a decoration image, a value is added to the decoration image, thereby motivating visitors of an event to come to each booth. Naturally, a decoration image may be a decoration image which is different for each of large regions, such as for each of prefectures, not for each of such limited areas, and, for example, may be an image of a famous place of each region.

The following will describe configurations of the game apparatus 101 and the server 103 which are used in the first embodiment.

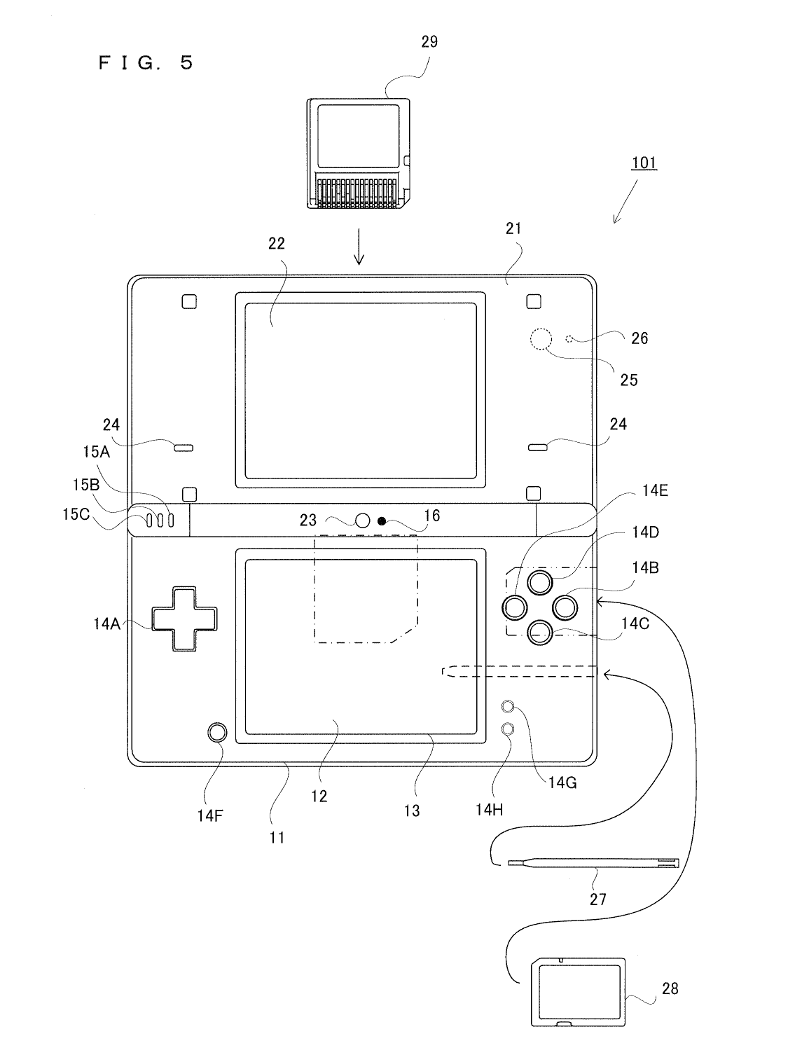

FIG. 5 is an external view of the game apparatus 101 according to the present embodiment. Here, as an example of the game apparatus 101, a hand-held game apparatus is shown. The game apparatus 101 has a camera, and thus functions as an imaging apparatus to take an image with the camera, to display the taken image on a screen, and to store data of the taken image.

As shown in FIG. 5, the game apparatus 101 is a foldable apparatus in an opened state. The game apparatus 101 is configured to have such a size as to be held by a user with both hands or one hand.

The game apparatus 101 includes a lower housing 11 and an upper housing 21. The lower housing 11 and the upper housing 21 are connected to each other so as to be capable of being opened or closed (foldable). In the example of FIG. 5, the lower housing 11 and the upper housing 21 are each formed in a plate-like shape of a horizontally long rectangle, and foldably connected to each other at long side portions thereof. Unusually, the user uses the game apparatus 101 in the opened state. When not using the game apparatus 101, the user keeps the game apparatus 1 in a closed state. In the example shown in FIG. 5, in addition to the closed state and the opened state, the game apparatus 101 is capable of maintaining an angle between the lower housing 11 and the upper housing 21 at any angle ranging between the closed state and the opened state by frictional force generated at a connection portion, and the like. In other words, the upper housing 21 can be stationary at any angle with respect to the lower housing 11.

In the lower housing 11, a lower LCD (Liquid Crystal Display) 12 is provided. The lower LCD 12 has a horizontally long shape, and is located such that a long side direction thereof corresponds to a long side direction of the lower housing 11. It is noted that although an LCD is used as a display device provided in the game apparatus 101 in the present embodiment, any other display devices such as a display device using an EL (Electro Luminescence), and the like may be used. In addition, the game apparatus 101 can use a display device of any resolution. Although details will be described later, the lower LCD 12 is used mainly for displaying an image taken by an inner camera 23 or an outer camera 25 in real time.

In the lower housing 11, operation buttons 14A to 14K are provided as input devices. As shown in FIG. 5, among the operation buttons 14A to 14K, the direction input button 14A, the operation button 14B, the operation button 14C, the operation button 14D, the operation button 14E, the power button 14F, the start button 14G, and the select button 14H are provided on an inner main surface of the lower housing 11 which is located inside when the upper housing 21 and the lower housing 11 are folded. The direction input button 14A is used, for example, for a selection operation, and the like. The operation buttons 14B to 14E are used, for example, for a determination operation, a cancellation operation, and the like. The power button 14F is used for turning on or off the power of the game apparatus 101. In the example shown in FIG. 5, the direction input button 14A and the power button 14F are provided on the inner main surface of the lower housing 11 and on one of a left side and a right side (on the left side in FIG. 5) of the lower LCD 12 provided in the vicinity of a center of the inner main surface of the lower housing 11. Further, the operation buttons 14B to 14E, the start button 14G, and the select button 14H are provided on the inner main surface of the lower housing 11 and on the other of the left side and the right side (on the right side in FIG. 5) of the lower LCD 12. The direction input button 14A, the operation buttons 14B to 14E, the start button 14G, and the select button 14H are used for performing various operations with respect to the game apparatus 101.

It is noted that the operation buttons 14I to 14K are omitted in FIG. 5. For example, the L button 14I is provided at a left end of an upper surface of the lower housing 11, and the R button 14J is provided at a right end of the upper surface of the lower housing 11. The L button 14I and the R button 14J are used, for example, for performing a photographing instruction operation (shutter operation) with respect to the game apparatus 101. In addition, the volume button 14K is provided on a left side surface of the lower housing 11. The volume button 14K is used for adjusting volume of speakers of the game apparatus 101.

The game apparatus 101 further includes a touch panel 13 as another input device in addition to the operation buttons 14A to 14K. The touch panel 13 is mounted on the lower LCD 12 so as to cover a screen of the lower LCD 12. In the present embodiment, the touch panel 13 is, for example, a resistive film type touch panel. However, the touch panel 13 is not limited to the resistive film type, but any press-type touch panel may be used. The touch panel 13 used in the present embodiment has the same resolution (detection accuracy) as that of the lower LCD 12. However, the resolution of the touch panel 13 and the lower LCD 12 may not necessarily be the same as each other. In a right side surface of the lower housing 11, an insertion opening (indicated by a dotted line in FIG. 5) is provided. The insertion opening is capable of accommodating a touch pen 27 which is used for performing an operation with respect to the touch panel 13. Although an input with respect to the touch panel 13 is usually performed using the touch pen 27, in addition to the touch pen 27, a finger of the user can be used for operating the touch panel 13.

In the left side surface of the lower housing 11, an insertion opening (indicated by a two-dot chain line in FIG. 5) is formed for accommodating a memory card 28. Inside the insertion opening, a connector (not shown) is provided for electrically connecting the game apparatus 101 to the memory card 28. The memory card 28 is, for example, an SD (Secure Digital) memory card, and detachably mounted to the connector. The memory card 28 is used, for example, for storing an image taken by the game apparatus 101, and loading an image generated by another apparatus into the game apparatus 101.

Further, in the upper surface of the lower housing 11, an insertion opening (indicated by a chain line in FIG. 5) is formed for accommodating a memory card 29. Inside the insertion opening, a connector (not shown) is provided for electrically connecting the game apparatus 101 to the memory card 29. The memory card 29 is a storage medium storing an information processing program, a game program, and the like, and detachably mounted in the insertion opening provided in the lower housing 11.

Three LEDs 15A to 15C are mounted to a left side part of the connection portion where the lower housing 11 and the upper housing 21 are connected to each other. The game apparatus 101 is capable of performing wireless communication with another apparatus, and the first LED 15A is lit up while wireless communication is established. The second LED 15B is lit up while the game apparatus 101 is charged. The third LED 15C is lit up while the power of the game apparatus 101 is ON. Thus, by the three LEDs 15A to 15C, a state of communication establishment of the game apparatus 101, a state of charge of the game apparatus 101, and a state of ON/OFF of the power of the game apparatus 101 can be notified to the user.

Meanwhile, in the upper housing 21, an upper LCD 22 is provided. The upper LCD 22 has a horizontally long shape, and is located such that a long side direction thereof corresponds to a long side direction of the upper housing 21. Similarly as the lower LCD 12, a display device of another type having any resolution may be used instead of the upper LCD 22. A touch panel may be provided so as to cover the upper LCD 22.

In the upper housing 21, two cameras (the inner camera 23 and the outer camera 25) are provided. As shown in FIG. 5, the inner camera 23 is mounted in an inner main surface of the upper housing 21 and in the connection portion. On the other hand, the outer camera 25 is mounted in a surface opposite to the surface in which the inner camera 23 is mounted, namely, in an outer main surface of the upper housing 21 (which is a surface located on the outside of the game apparatus 101 in the closed state, and a back surface of the upper housing 21 shown in FIG. 5). In FIG. 5, the outer camera 25 is indicated by a dashed line. Thus, the inner camera 23 is capable of taking an image in a direction in which the inner main surface of the upper housing 21 faces, and the outer camera 25 is capable of taking an image in a direction opposite to an imaging direction of the inner camera 23, namely, in a direction in which the outer main surface of the upper housing 21 faces. In other words, in the present embodiment, the two cameras 23 and 25 are provided such that the imaging directions thereof are opposite to each other. For example, the user can take an image of a view seen from the game apparatus 101 toward the user with the inner camera 23 as well as an image of a view seen from the game apparatus 101 in a direction opposite to the user with the outer camera 25.

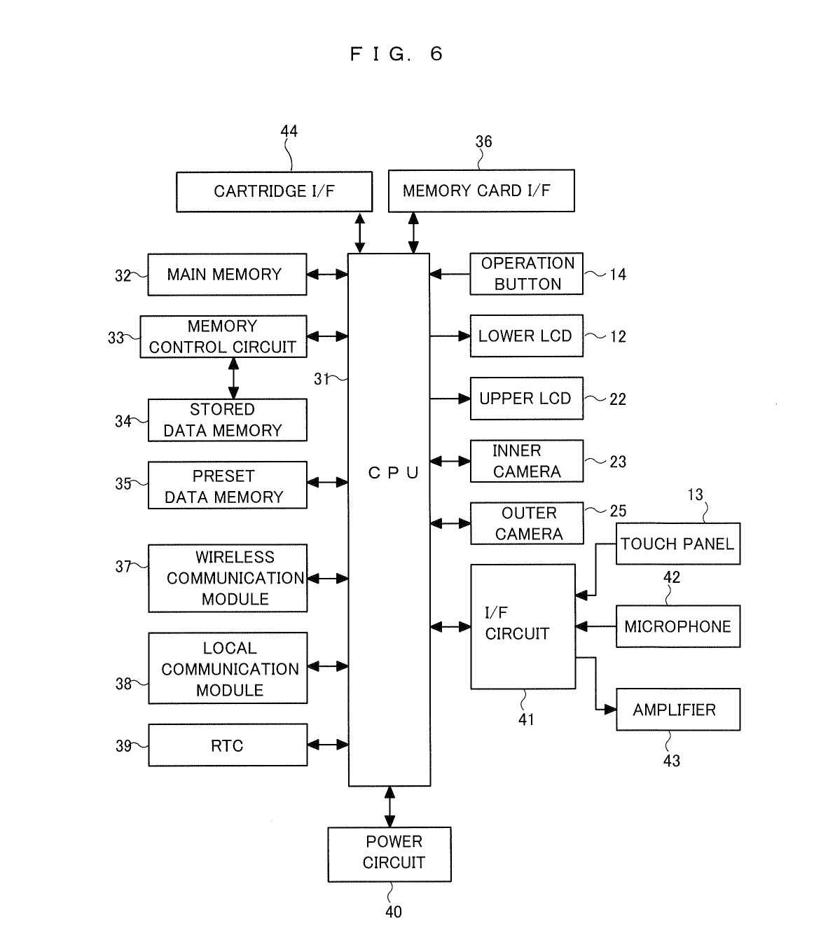

In the inner main surface of the upper housing 21 and in the connection portion, a microphone (a microphone 42 shown in FIG. 6) is accommodated as a voice input device. In the inner main surface of the upper housing 21 and in the connection portion, a microphone hole 16 is formed to allow the microphone 42 to detect sound outside the game apparatus 101. The accommodating position of the microphone 42 and the position of the microphone hole 16 are not necessarily in the connection portion. For example, the microphone 42 may be accommodated in the lower housing 11, and the microphone hole 16 may be formed in the lower housing 11 so as to correspond to the accommodating position of the microphone 42.

In the outer main surface of the upper housing 21, a fourth LED 26 (indicated by a dashed line in FIG. 5) is mounted. The fourth LED 26 is lit up at a time when photographing is performed with the inner camera 23 or the outer camera 25 (when the shutter button is pressed). Further, the fourth LED 26 is lit up while a moving picture is taken by the inner camera 23 or the outer camera 25. By the fourth LED 26, it is notified to an object person whose image is taken and people around the object person that photographing is performed (being performed) by the game apparatus 101.

Sound holes 24 are formed in the inner main surface of the upper housing 21 and on left and right sides, respectively, of the upper LCD 22 provided in the vicinity of a center of the inner main surface of the upper housing 21. The speakers are accommodated in the upper housing 21 and at the back of the sound holes 24. The sound holes 24 are for releasing sound from the speakers to the outside of the game apparatus 101 therethrough.

As described above, the inner camera 23 and the outer camera 25 which are configurations for taking an image, and the upper LCD 22 which is display means for displaying various images are provided in the upper housing 21. On the other hand, the input devices for performing an operation input with respect to the game apparatus 101 (the touch panel 13 and the buttons 14A to 14K), and the lower LCD 12 which is display means for displaying various images are provided in the lower housing 11. For example, when using the game apparatus 101, the user can hold the lower housing 11 and perform an input with respect to the input device while a taken image (an image taken by the camera) is displayed on the lower LCD 12 and the upper LCD 22.

The following will describe an internal configuration of the game apparatus 101 with reference to FIG. 6. FIG. 6 is a block diagram showing an example of the internal configuration of the game apparatus 101.

As shown in FIG. 6, the game apparatus 101 includes electronic components including a CPU 31, a main memory 32, a memory control circuit 33, a stored data memory 34, a preset data memory 35, a memory card interface (memory card I/F) 36, a wireless communication module 37, a local communication module 38, a real time clock (RTC) 39, a power circuit 40, an interface circuit (I/F circuit) 41, and the like. These electronic components are mounted on an electronic circuit substrate and accommodated in the lower housing 11 (or may be accommodated in the upper housing 21).

The CPU 31 is information processing means for executing a predetermined program. In the present embodiment, the predetermined program is stored in a memory (e.g. the stored data memory 34) within the game apparatus 101 or in the memory cards 28 and/or 29, and the CPU 31 executes later-described information processing by executing the predetermined program. It is noted that a program executed by the CPU 31 may be stored in advance in a memory within the game apparatus 101, may be obtained from the memory cards 28 and/or 29, or may be obtained from another apparatus by means of communication with the other apparatus.

The main memory 32, the memory control circuit 33, and the preset data memory 35 are connected to the CPU 31. The stored data memory 34 is connected to the memory control circuit 33. The main memory 32 is storage means used as a work area and a buffer area of the CPU 31. In other words, the main memory 32 stores various data used in the information processing, and also stores a program obtained from the outside (the memory cards 28 and 29, another apparatus, and the like). In the present embodiment, for example, a PSRAM (Pseudo-SRAM) is used as the main memory 32. The stored data memory 34 is storage means for storing a program executed by the CPU 31, data of images taken by the inner camera 23 and the outer camera 25, and the like. The stored data memory 34 is constructed of a nonvolatile storage medium, for example, a NAND flash memory. The memory control circuit 33 is a circuit for controlling reading of data from the stored data memory 34 or writing of data to the stored data memory 34 in accordance with an instruction from the CPU 31. The preset data memory 35 is storage means for storing data (preset data) of various parameters which are set in advance in the game apparatus 101, and the like. A flash memory connected to the CPU 31 via an SPI (Serial Peripheral Interface) bus can be used as the preset data memory 35.

The memory card I/F 36 is connected to the CPU 31. The memory card I/F 36 reads data from the memory card 28 and the memory card 29 which are mounted to the connectors or writes data to the memory card 28 and the memory card 29 in accordance with an instruction from the CPU 31. In the present embodiment, data of images taken by the inner camera 23 and the outer camera 25 are written to the memory card 28, and image data stored in the memory card 28 are read from the memory card 28 to be stored in the stored data memory 34. Various programs stored in the memory card 29 are read by the CPU 31 to be executed.

A cartridge I/F 44 is connected to the CPU 31. The cartridge I/F 44 reads out data from the cartridge 29 mounted to the connector or writes data to the cartridge 29 in accordance with an instruction from the CPU 31. In the present embodiment, an application program executable by the game apparatus 101 is read out from the cartridge 29 to be executed by the CPU 31, and data regarding the application program (e.g. saved data, and the like) is written to the cartridge 29.

The information processing program according to the present embodiment may be supplied to a computer system via a wired or wireless communication line, in addition to from an external storage medium such as the memory card 29, and the like. The information processing program may be stored in advance in a nonvolatile storage unit within the computer system. An information storage medium for storing the information processing program is not limited to the above nonvolatile storage unit, but may be a CD-ROM, a DVD, or an optical disc-shaped storage medium similar to them.

The wireless communication module 37 functions to connect to a wireless LAN device, for example, by a method conformed to the standard of IEEE802.11.b/g. The local communication module 38 functions to wirelessly communicate with a game apparatus of the same type by a predetermined communication method. The wireless communication module 37 and the local communication module 38 are connected to the CPU 31. The CPU 31 is capable of receiving data from and transmitting data to another apparatus via the Internet using the wireless communication module 37, and capable of receiving data from and transmitting data from another game apparatus of the same type using the local communication module 38.

The RTC 39 and the power circuit 40 are connected to the CPU 31. The RTC 39 counts a time, and outputs the time to the CPU 31. For example, the CPU 31 is capable of calculating a current time (date), and the like based on the time counted by the RTC 39. The power circuit 40 controls electric power from a power supply (typically, a battery accommodated in the lower housing 11) of the game apparatus 101 to supply the electric power to each electronic component of the game apparatus 101.

The game apparatus 101 includes the microphone 42 and an amplifier 43. The microphone 42 and the amplifier 43 are connected to the I/F circuit 41. The microphone 42 detects voice produced by the user toward the game apparatus 101, and outputs a sound signal indicative of the voice to the I/F circuit 41. The amplifier 43 amplifies the sound signal from the I/F circuit 41, and causes the speakers (not shown) to output the sound signal. The I/F circuit 41 is connected to the CPU 31.

The touch panel 13 is connected to the I/F circuit 41. The I/F circuit 41 includes a sound control circuit for controlling the microphone 42 and the amplifier 43 (the speakers), and a touch panel control circuit for controlling the touch panel 13. The sound control circuit performs A/D conversion or D/A conversion with respect to the sound signal, and converts the sound signal into sound data in a predetermined format. The touch panel control circuit generates touch position data in a predetermined format based on a signal from the touch panel 13, and outputs the touch position data to the CPU 31. For example, the touch position data is data indicative of coordinates of a position at which an input is performed with respect to an input surface of the touch panel 13. The touch panel control circuit reads a signal from the touch panel 13 and generates touch position data every a predetermined time period. The CPU 31 is capable of recognizing a position at which an input is performed with respect to the touch panel 13 by obtaining the touch position data.

An operation button 14 includes the above operation buttons 14A to 14K, and is connected to the CPU 31. The operation button 14 outputs operation data indicative of an input state with respect to each of the buttons 14A to 14K (whether or not each button is pressed) to the CPU 31. The CPU 31 obtains the operation data from the operation button 14, and executes processing in accordance with an input with respect to the operation button 14.

The inner camera 23 and the outer camera 25 are connected to the CPU 31. Each of the inner camera 23 and the outer camera 25 takes an image in accordance with an instruction from the CPU 31, and outputs data of the taken image to the CPU 31. For example, the CPU 31 gives an imaging instruction to the inner camera 23 or outer camera 25, and the camera which has received the imaging instruction takes an image and transmits image data to the CPU 31.

The lower LCD 12 and the upper LCD 22 are connected to the CPU 31. Each of the lower LCD 12 and the upper LCD 22 displays an image thereon in accordance with an instruction from the CPU 31. For example, the CPU 31 causes the lower LCD 12 to display thereon an image obtained from the inner camera 23 or the inner camera 25, and the upper LCD 22 to display thereon an operation explanation screen generated by predetermined processing.

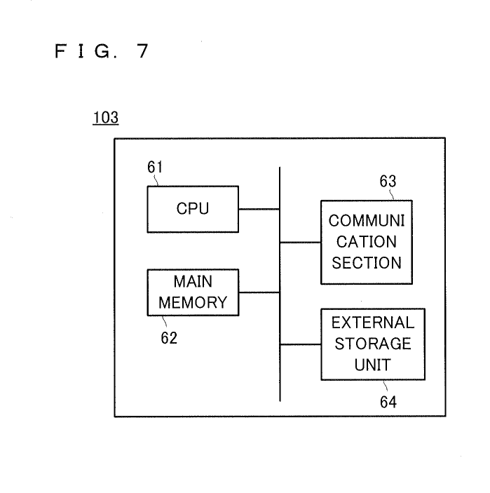

The following will describe the server 103 used in the first embodiment. FIG. 7 is a functional block diagram showing a configuration of the server 103 according to the first embodiment. As shown in FIG. 7, the server 103 includes a CPU 61, a main memory 62, a communication section 63, and an external storage unit 64.

The CPU 61 controls processing according to the present embodiment by executing a later-described program. Into the main memory 62, necessary various programs and data are loaded from the external storage unit 64 as needed when the processing according to the present embodiment is executed. The communication section 63 performs communication with the game apparatus 101, and the like based on control of the CPU 61. The external storage unit 64 is a medium for storing various programs and data which are to be loaded into the main memory 62, and, for example, corresponds to a hard disk drive.

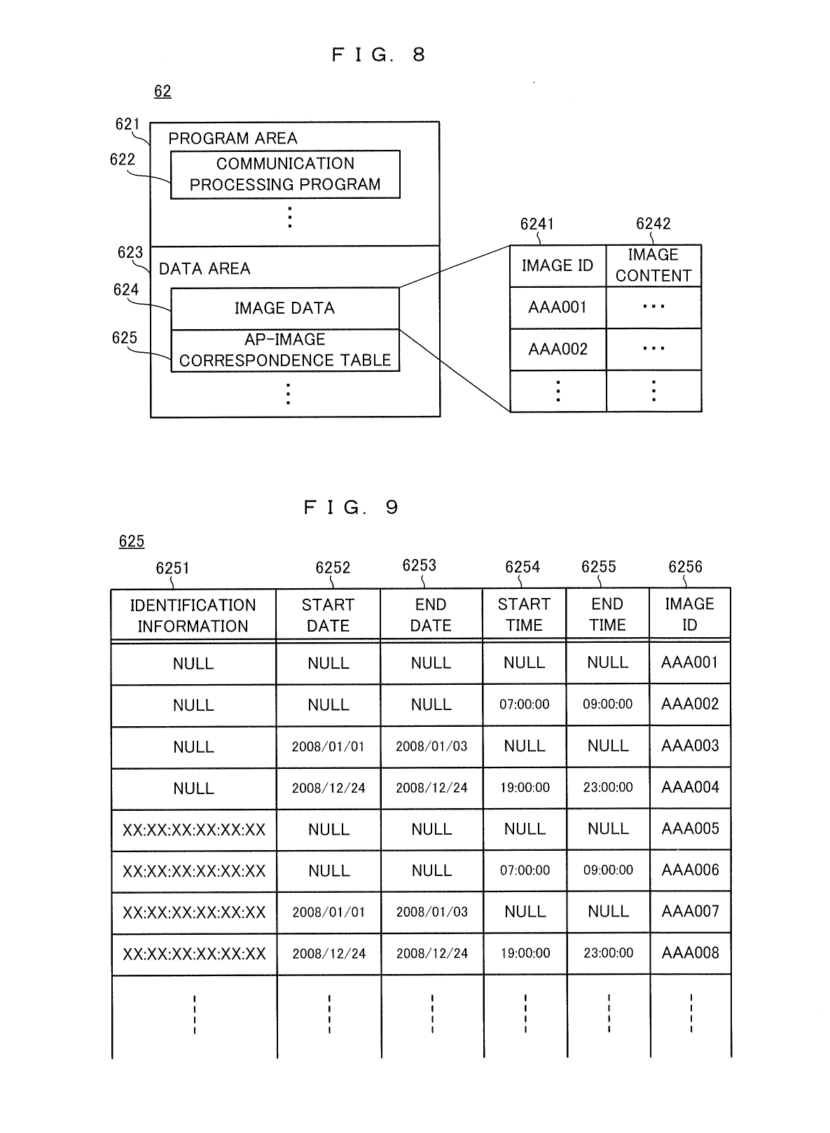

The following will describe various data used in the first embodiment. First, data stored in the server 103 will be described. FIG. 8 is a view showing a memory map of the main memory 62 of the server 103 shown in FIG. 7. As shown in FIG. 8, the main memory 62 includes a program area 621 and a data area 623. The program area 621 stores a communication processing program 622 which is to be executed by the CPU 61, and the like. The communication processing program 622 is a program for performing communication with the game apparatus 101, transmitting data of a decoration image, and the like.

In the data area 623, image data 624 and an AP-image correspondence table 625 are stored. The image data 624 is data of a decoration image as described above, and includes an image ID 6241 for uniquely identifying each image and an image content 6242 which is information indicative of an actual image. In addition, in the data area 623, various data used in communication processing with the game apparatus 101, and the like are stored.

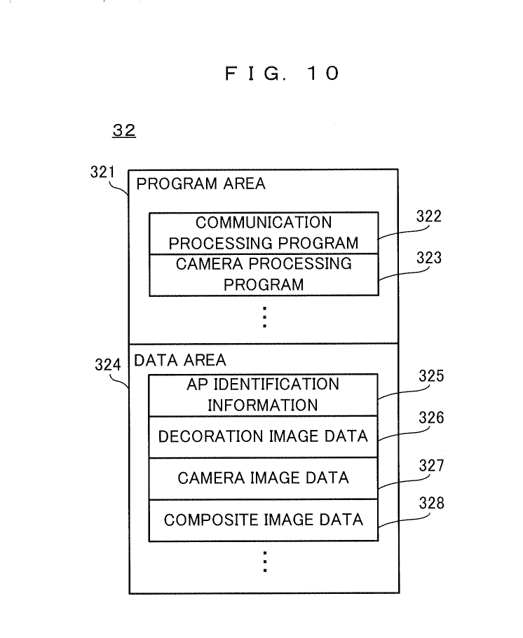

FIG. 9 is a view showing an example of the above AP-image correspondence table 625. This table defines correspondence between identification information of an AP 102 which is transmitted from the game apparatus 101 and the above decoration image. The AP-image correspondence table 625 shown in FIG. 9 includes identification information 6251, a start date 6252, an end date 6253, a start time 6254, an end time 6255, and an image ID 6256.

The identification information 6251 is information for identifying the above AP 102, and, for example, an SSID of the AP 102 is registered therein. In addition to the SSID, an ESSID (Extended Service Set Identifier) and a BSSID (Basic Service Set Identifier: MAC address) may be used as the identification information 6251.

The start date 6252 and the end date 6253 are information for indicating a valid period (i.e. a transmittable period, or an available period) for a decoration image. For example, a decoration image for which the start date 6252 is set as “2008 Jan. 1” and the end date 6253 is set as “2008 Jan. 3” can be obtained only during a period from 2008 Jan. 1 to January 3. Similarly, the start time 6254 and the end time 6255 are information for indicating a time period during which a decoration image is transmittable from the server 103. In other words, the start time 6254 and the end time 6255 indicates that the decoration image is available during a limited time period.

The image ID 6256 is data corresponding to the image ID 6241 of the above image data 624.

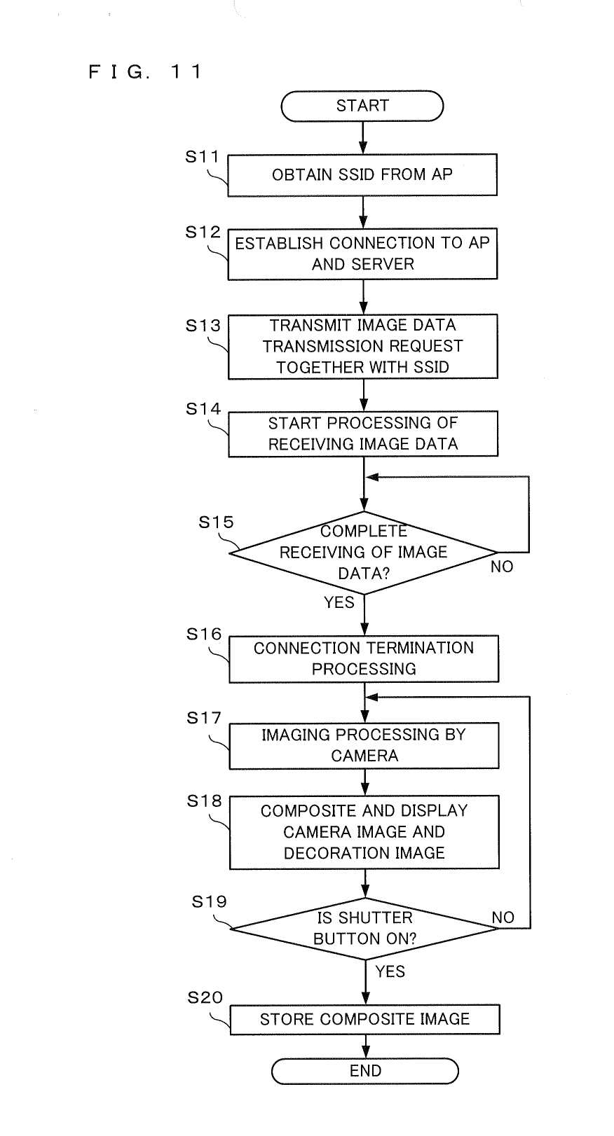

The following will describe data regarding the game apparatus 101. FIG. 10 is a view showing a memory map of the main memory 32 of the game apparatus 101. As shown in FIG. 10, the main memory 32 includes a program area 321 and a data area 324. The program area 321 stores a program which is to be executed by the CPU 31, and the program includes a communication processing program 322, a camera processing program 323, and the like.

The communication processing program 322 is a program for performing communication with the server 103 and executing processing of obtaining the data of the above decoration image. The camera processing program 323 is program for executing imaging processing by means of the outer camera 25 (or the inner camera 23) using the data of the decoration image obtained from the server 103.

In the data area 324, AP identification information 325, decoration image data 326, camera image data 327, and composite image data 328 are stored.

The AP identification information 325 is information, such as an SSID, and the like, which is obtained from an AP 102 when communication is performed with the server 103. When requesting the server 103 to transmit a decoration image, the AP identification information 325 is transmitted from the game apparatus 101 to the server 103.

The decoration image data 326 is data of a decoration image which is transmitted from the server 103 and stored. The camera image data 327 is data of an image taken by the outer camera 25 (or the inner camera 23). The composite image data 328 is data of an image obtained by compositing the decoration image data 326 and the above camera image data 327. When the shutter button is pressed, the composite image data 328 is finally stored in the memory card 28, and the like.

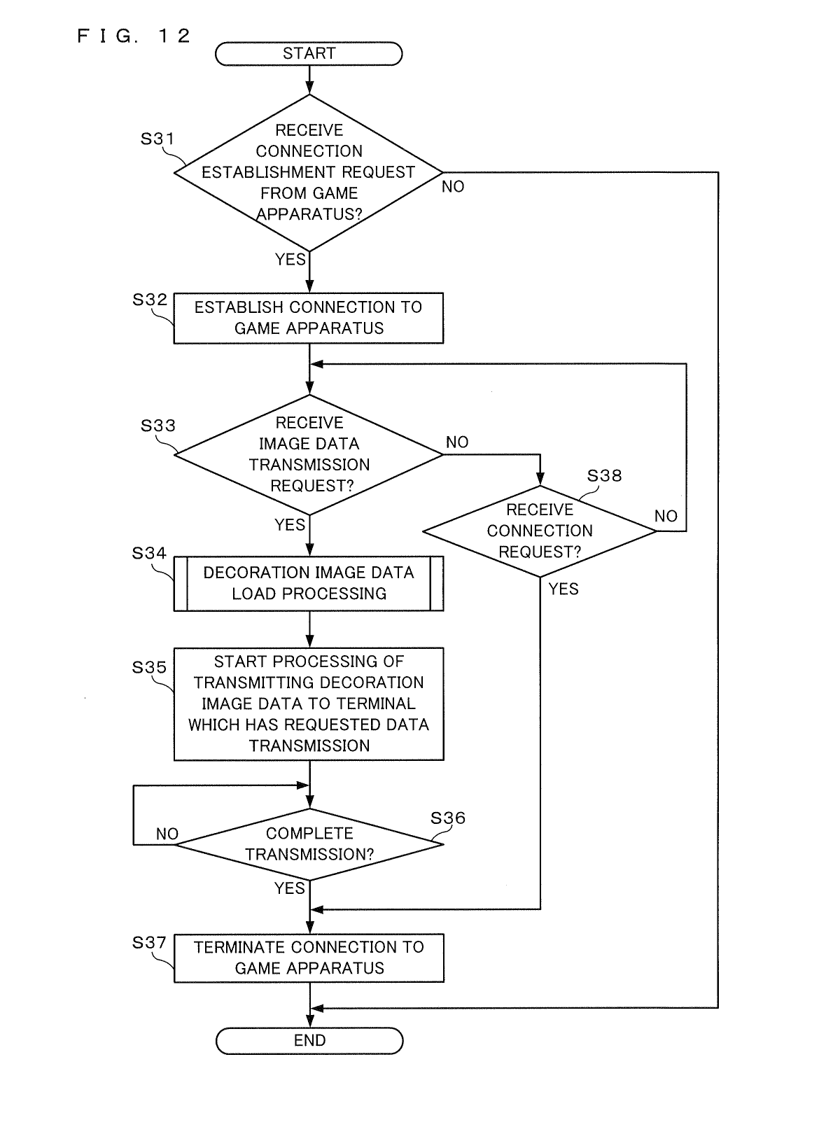

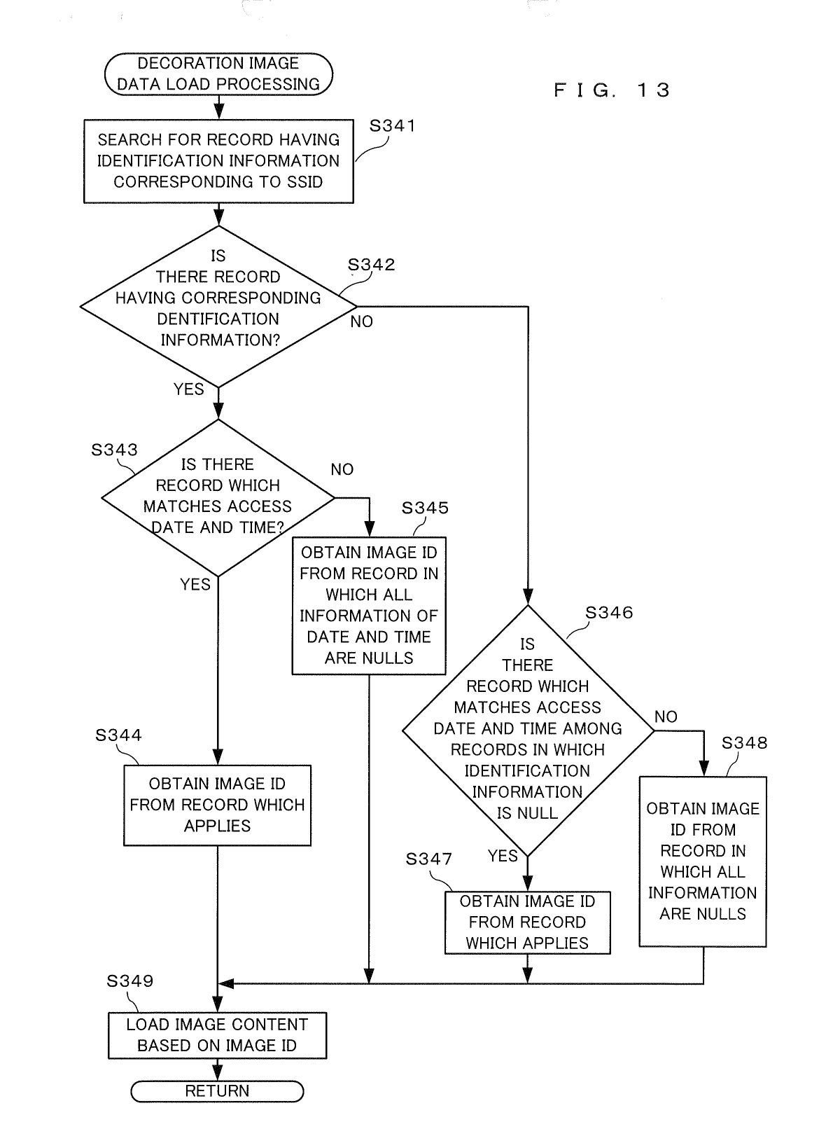

The following will describe in detail processing executed by the game apparatus 101 and the server 103 with reference to FIGS. 11 and 12. First, the processing executed by the game apparatus 101 will be described. FIG. 11 is a flow chart showing in detail imaging processing executed by the game apparatus 101. This processing is started to execute, for example, when the user selects camera activation processing from a system menu (not shown) displayed on the LCD 22 of the game apparatus 101. In FIG. 11, processing at steps S11 to S16 is achieved by the above communication processing program 322, and processing at steps S17 to S20 is achieved by the camera processing program 323. The processing in FIG. 11 is repeatedly executed every one frame.

As shown in FIG. 11, the CPU 31 executes processing of obtaining identification information, for example, an SSID, from an AP 102 (the step S11). More specifically, the CPU 31 obtains a signal broadcasted from the AP 102, and extracts the SSID included in the signal, thereby detecting the AP 102. When a plurality of APs are detected, the CPU 31 may select an AP having the largest radio wave intensity, or a list of the detected APs may be displayed on the lower LCD 12 or the upper LCD 22, and the user may select a desired AP.

Next, the CPU 31 establishes connection to the AP 102 indicated by the obtained SSID. In addition, the CPU 31 transmits a connection establishment request to the server 103 via the AP 102, and establishes connection to the server 103 (the step S12). Basic processing of establishing connection to the AP and the server 103 is known to those skilled in the art, and thus detailed description thereof will be omitted.

Next, the CPU 31 transmits information for requesting to transmit a decoration image (hereinafter, referred to as an image data transmission request) to the server 103 together with the SSID obtained at the step S11 (the step S13).

Next, the CPU 31 starts processing of receiving data (image content 6242) of a decoration image which is transmitted from the server 103 (the step S14).

Subsequently, the CPU 31 determines whether or not the receiving of the above image data has been completed (the step S15). When the receiving has not been completed (NO at the step S15), the CPU 31 continues the receiving processing until the receiving is completed. On the other hand, when the receiving has been completed (YES at the step S15), the CPU 31 stores the received image data as the decoration image data 326 in the main memory 32. At this time, the CPU 31 transmits to the server 103 a receiving completion notice for indicating that the receiving has been completed. The CPU 31 executes processing for terminating the connection to the server 103 and the AP 102 (the step S16). For example, after transmitting to the server 103 a disconnect request which is a signal including an instruction to terminate the connection, the CPU 31 terminates the connection to the network.

Next, the CPU 31 executes imaging processing by the outer camera 25 (or the inner camera 23) (the step S17). In other words, the CPU 31 stores image data of a view caught by the outer camera 25 (or the inner camera 23) as the camera image data 327 in the main memory 32.

Next, the CPU 31 composites the decoration image data 326 obtained at the step S14 and the camera image data 327 to generate composite image data 328. Then, the CPU 31 displays a composite image on the lower LCD 12 (the step S18). Thus, the user can visually confirm what composite image can be taken.

Next, the CPU 31 determines whether or not the shutter button has been pressed (the step S19). In the present embodiment, the shutter button is assigned to the R button 14J. As a result of the determination, when the CPU 31 determines that the shutter button has not been pressed (NO at the step S19), the CPU 31 returns to the processing at the step S17, and repeats processing of displaying a composite image of a camera image and the above decoration image on the lower LCD 12.

On the other hand, as the result of the determination at the step S19, when the CPU 31 determines that the shutter button has been pressed (YES at the step S19), the CPU 31 executes processing of storing the composite image data 328 in the memory card 28 (the step S20). This is the end of the processing executed by the game apparatus 101.

The following will describe the processing executed by the server 103. FIG. 12 is a flow chart showing in detail communication processing executed by the server 103. The processing in FIG. 12 is repeatedly executed every one frame.

First, the CPU 61 of the server 103 determines whether or not the CPU 61 has received the connection establishment request from the game apparatus 101 (a step S31). As a result of the determination, when the CPU 61 has not received the connection establishment request (NO at the step S31), the CPU 61 terminates the processing. On the other hand, when the CPU 61 has received the connection establishment request (YES at the step S31), the CPU 61 executes processing of establishing connection to the game apparatus 101 which has transmitted the connection establishment request (a step S32).

Next, the CPU 61 determines whether or not the CPU 61 has received the image data transmission request transmitted from the game apparatus 101 (a step S33). As a result of the determination, when the CPU 61 has not received the image data transmission request (NO at the step S33), the CPU 61 determines whether or not the CPU 61 has received the disconnect request from the game apparatus 101 (a step S38). When the CPU 61 has received the disconnect request (YES at the step S38), the CPU 61 advances to processing at a later-described step S37, and executes processing for terminating the connection to the game apparatus 101. On the other hand, when the CPU has not received the disconnect request (NO at the step S38), the CPU 61 repeats the processing at the step S33.

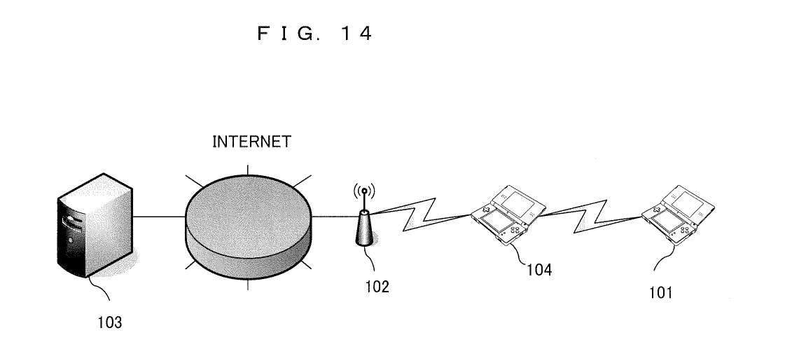

On the other hand, as the result of the determination at the step S33, when the CPU 61 has received the image data transmission request (YES at the step S33), the CPU 61 executes decoration image data load processing of loading image data based on the SSID transmitted from the game apparatus 101 (a step S34). FIG. 13 is a flow chart showing in detail the decoration image data load processing. As shown in FIG. 13, the CPU 61 refers to the AP-image correspondence table 625, and searches for a record including a value of the identification information 6251 which is the same as the SSID transmitted from the game apparatus 101 (one record corresponds to one row of the table shown in FIG. 9) (a step S341). As a result of the searching, a plurality of records may be found. For example, when there are records in which values of the identification information 6251 are the same as each other but different values are set for the start date 6252 and the end date 6253 or for the start time 6254 and the end time 6255, a group of these records is obtained as a search result. Hereinafter, when a search result is either one record or a plurality of records, the one record and the plurality of records are each referred to as a “record group”.

Next, as the result of the searching, the CPU 61 determines whether there is a record group having the same value of the identification information 6251 as the SSID (a step S342). As a result of the determination, when there is a record group having the same value of the identification information 6251 as the SSID (YES at the step S342), the CPU 61 determines whether or not, among the record group found at the step S341, there is a record of which the start date 6252, the end date 6253, the start time 6254, and the end time 6255 define a date and time range including date and time (hereinafter, referred to as access date and time. The access date and time are obtained from a built-in clock of the server 103) at which the CPU 61 receives the image data transmission request (a step S343). In other words, the CPU 61 determines whether or not the access date and time match a condition of date and time which are set in each record of the found record group. When the search result is one record, the CPU 61 determines whether or not the access date and time match the record. As a result of the determination, when there is a record in which a date and time range including the access date and time is set (YES at the step S343), the CPU 61 obtains the image ID 6256 from the record (a step S344), and then advances to processing at a later-described step S349.

On the other hand, as the result of the determination at the step S343, when there is no record in which a date and time range including the access date and time is set (NO at the step S343), the CPU 61 obtains the image ID 6256 from a record in which NULLs are set for all of the start date 6252, the end date 6253, the start time 6254, and the end time 6255 (corresponding to a fifth record from the top in the example of FIG. 9) (a step S345), and then advances to processing at the later-described step S349.

On the other hand, as the result of the determination at the step S342, when there is no record having the same value of the identification information 6251 as the SSID (NO at the step S342), the CPU 61 searches for a record group in which NULL is set for the identification information 6251 (corresponding to first to fourth records from the top in the example of FIG. 9), and determines whether or not, among a found record group, there is a record in which a date and time range including the access date and time is set (whether or not there is a record of which a condition of date and time matches the access date and time) (a step S346). As a result, when there is a record in which a date and time record including the access date and time is set (YES at the step S346), the CPU 61 obtains the image ID 6256 from the record (a step S347). On the other hand, when there is no record of which a condition of date and time matches the access date and time (NO at the step S346), the CPU 61 searches for a record in which all values are NULL values (the first record from the top in the example of FIG. 9), and obtains the image ID 6256 from the record (a step S348).

Next, the CPU 61 refers to the image data 624, and obtains the image content 6242 based on the obtained image ID 6256 (a step S349). This is the end of the decoration image data load processing.

Referring back to FIG. 12, after obtaining the data of the decoration image, the CPU 61 starts processing of transmitting the data (the image content 6242) of the decoration image to the game apparatus 101 (a step S35).

Subsequently, the CPU 61 determines whether or not the transmitting processing has been completed (a step S36). For example, the CPU 61 makes the determination by determining whether or not the CPU 61 has received the receiving competition notice transmitted from the game apparatus 101. As a result of the determination, when the transmitting has not been completed (NO at the step S36), the CPU 61 continues the transmitting processing until the transmitting is completed. On the other hand, when the transmitting has been completed (YES at the step S36), the CPU 61 waits for the disconnect request from the game apparatus 101, and then executes processing for terminating the connection to the game apparatus 101 (the step S37). This is the end of the processing executed by the server 103.

As described above, in the present embodiment, a decoration image which is different depending on identification information of an AP used by the game apparatus 101 for performing communication with the server 103 is transmitted to the game apparatus 101. Thus, it is possible to take a photograph including a decoration image which is different depending on a position where the game apparatus 101 accesses the server 103. In other words, when imaging is performed by means of the outer camera 25 (or the inner camera 23), imaging can be performed using a decoration image which is available only in a specific region (area) or on a specific date at a specific time, and thus a value can be added to each decoration image. As a result, it is possible to gather users who desire to perform imaging using a specific decoration image in a specific region (area) on a specific date at a specific time. Further, new enjoyment of seeking a specific region (area) and a specific date and time can be provided to the user, and by a result of the seeking, surprise can be provided to the user.

In the embodiment described above, when the server 103 loads an image, the condition matching determination is made with the identification information of the AP as well as the date and time of accessing the server 103 being taken into account. However, the condition matching determination is not limited thereto, and the condition matching determination may be made only for the identification information of the AP.

Further, when there is no record having identification information which matches identification information of an AP, a record having a date or a time which matches access date and time may be searched for. In addition, a preference order of a condition matching determination regarding identification information of an AP and a condition matching determination regarding date and time may be any order.

Further, when no record which matches a condition is found, decoration image data indicated by a record in which all values are NULL values is transmitted in the above embodiment, but, alternatively, information of an effect that there is no decoration image may be transmitted to the game apparatus 101. In this case, in the game apparatus 101, image compositing processing as described above is not executed, and an image taken by the outer camera 25 (or the inner camera 23) is displayed on the lower LCD 12 without change. In other words, even when communication is performed with the server 103, normally, a composite photograph as described above is not taken, and only when communication is performed with the server 103 at a specific place, a composite photograph including a decoration image according to the place may be taken.

### Second Embodiment

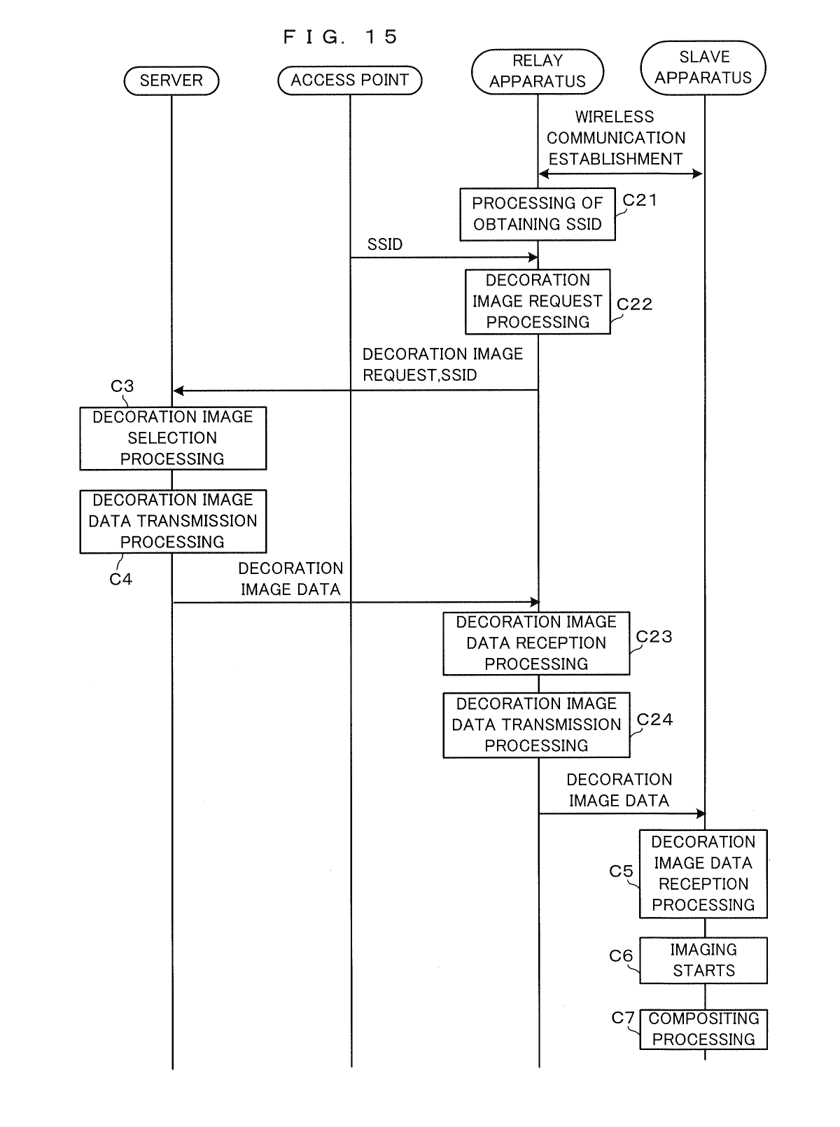

The following will describe a second embodiment with reference to FIGS. 14 to 17. In the above first embodiment, communication is performed between the server 103 and the game apparatus 101 via the AP 102. However, in the second embodiment, as shown in FIG. 14, processing is executed in a configuration in which a relay apparatus 104 having a relay function is added between an AP 102 and a game apparatus 101.

Here, the relay apparatus 104 according to the second embodiment will be described. In the second embodiment, it is assumed that a plurality of game apparatuses 101 perform wireless communication therebetween using their wireless communication modules 38 (not via an AP) (hereinafter, communication between the game apparatuses 101 is referred to as local communication). Among a plurality of game apparatuses 101 which are connected to each other by means of local communication, one game apparatus 101 performs communication with a server 103 via the AP 102. The game apparatus 101 which performs communication with the server 103 is referred to as the relay apparatus 104. In the description of the second embodiment, the game apparatuses 101 other than the relay apparatus 104 are referred to as slave apparatuses. Hereinafter, in the description of the second embodiment, the relay apparatus 104 and the slave apparatus 101 may be generically referred to merely as game apparatuses.

The server 103 and the game apparatuses (the relay apparatus 104 and the slave apparatus 101) according to the second embodiment have the same configurations as those described with reference to FIGS. 5 to 7 in the first embodiment. Thus, the same components are designated by the same reference characters, and the detailed description thereof will be omitted.

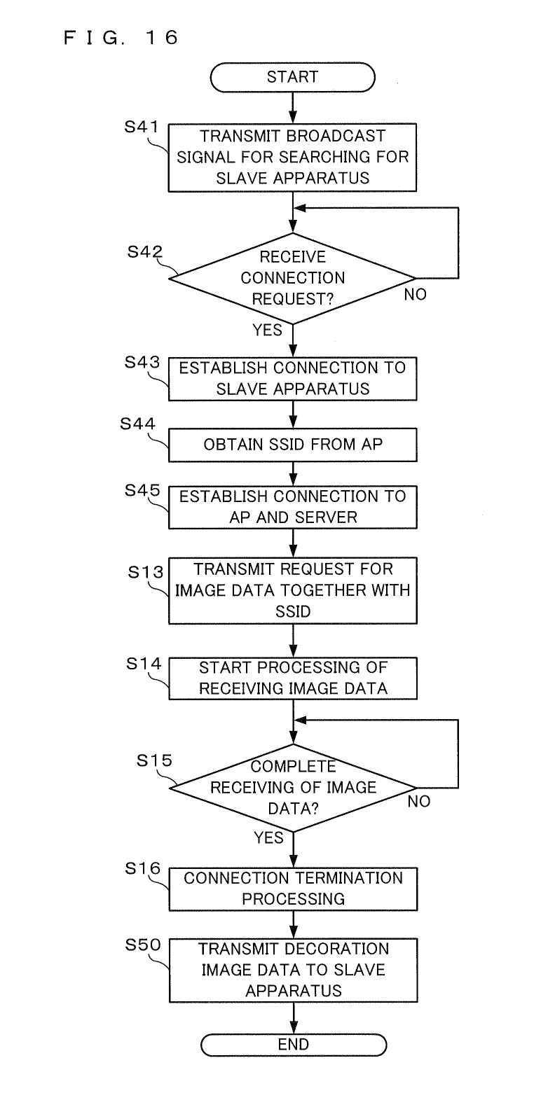

The following will describe an outline of processing according to the second embodiment with reference to FIG. 15. FIG. 15 is a view for explaining the outline of the processing according to the second embodiment. As shown in FIG. 15, first, processing of establishing connection is executed so as to enable the above local communication to be performed between the relay apparatus 104 and the slave apparatus 101. Then, the relay apparatus 104 obtains an SSID from the AP 102 using the wireless communication module 37, and executes processing of establishing connection to the AP 102 (C21).

Next, the relay apparatus 104 executes processing of establishing connection to a predetermined server 103 via the AP 102 and the Internet, and executes processing of requesting data of a decoration image from the server 103 (C22). At this time, the relay apparatus 104 also transmits the SSID obtained from the AP 102 to the server 103.

The server 103 executes processing of selecting a decoration image based on the SSID transmitted from the relay apparatus 104 (C3). Then, the server 103 executes processing of transmitting data of the selected decoration image to the relay apparatus 104 (C4).

The relay apparatus 104 executes processing of receiving the decoration image data transmitted from the server 103 (C23). Next, the relay apparatus 104 executes processing of transmitting the decoration image data received from the server 103 to the slave apparatus 101 which has been connected to the relay apparatus 104 by means of local communication (C24).

Next, the slave apparatus 101 executes processing of receiving the decoration image data transmitted from the relay apparatus 104 (C5). Then, similarly as in the first embodiment, the slave apparatus 101 activates the outer camera 25 (or the inner camera 23) to start imaging processing (C26), and executes compositing processing of compositing the received decoration image and a camera image (C7).

As described above, in the second embodiment, the relay apparatus 104 obtains the data of the decoration image from the server 103, and transmits the data to the slave apparatus 101. Thus, if there are a plurality of slave apparatuses 101, communication traffic between the server 103 and the AP 102 can be reduced as compared to the case where each slave apparatus 101 obtains data of a decoration image by individually performing communication with the server 103 using the wireless communication module 37.

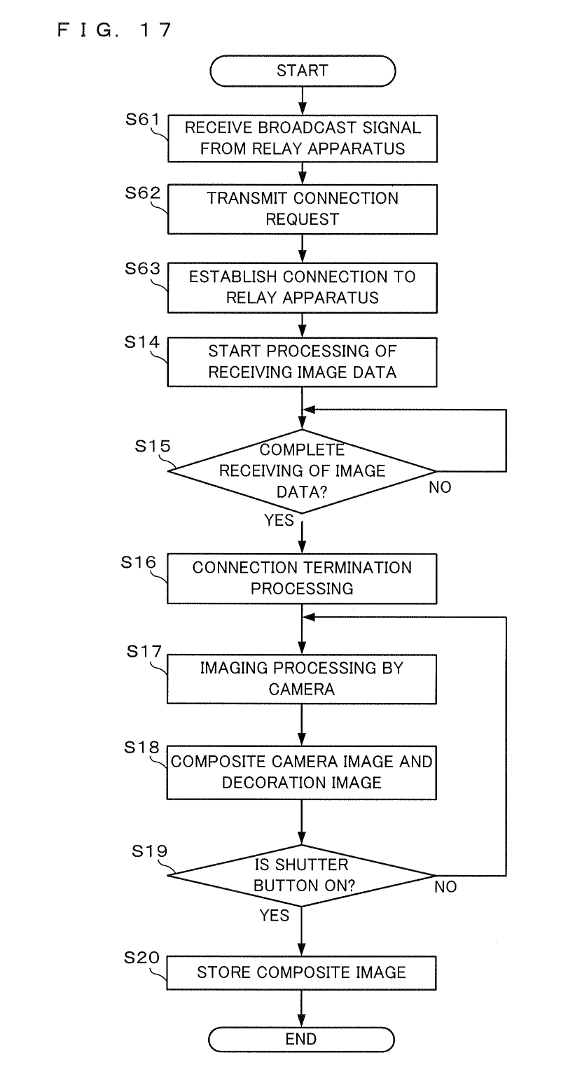

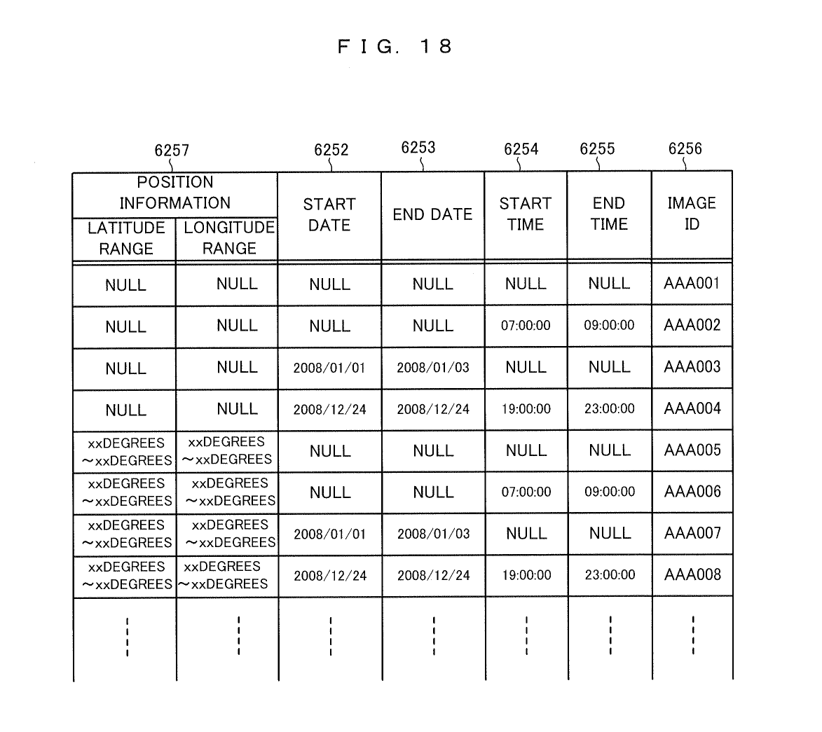

The following will describe in detail the processing according to the second embodiment with reference to FIGS. 16 and 17. Processing executed by the server 103 is the same as that in the first embodiment except for a fact that a communication partner is the relay apparatus 104, and thus detailed description thereof will be omitted.

First, processing executed by the relay apparatus 104 will be described. FIG. 16 is a flow chart showing in detail the processing executed by the relay apparatus 104. As shown in FIG. 16, a CPU 31 of the relay apparatus 104 transmits a broadcast signal using the wireless communication module 37 for searching for the slave apparatus 101 (a step S41).

Next, the CPU 31 determines whether or not the CPU 31 has received from the slave apparatus 101 a connection request by means of local communication (a step S42). As a result of the determination, when the CPU 31 has not received the connection request (NO at the step S42), the CPU 31 repeats the determination at the step S42 until the CPU 31 receives the connection request. On the other hand, when the CPU 31 has received the connection request (YES at the step S42), the CPU 31 executes processing of establishing connection to the slave apparatus 101 which has transmitted the connection request (a step S43).

Next, the CPU 31 executes processing of obtaining the SSID from the AP 102 (a step S44). Subsequently, the CPU 31 establishes connection to the AP 102 indicated by the SSID. Further, the CPU 31 transmits a connection establishment request to the server 103 via the AP 102, and establishes connection to the server 103 (a step S45).

After establishing the connection to the slave apparatus 101, the CPU 31 of the relay apparatus 104 executes processing of obtaining data of a decoration image from the server 103 using the wireless communication module 37 (steps S13 to S16). Processing at the steps S13 to S16 is the same as that at the steps S13 to S16 described with reference to FIG. 11 in the first embodiment, and thus description thereof will be omitted.

After obtaining the decoration image data from the server 103, the CPU 31 executes processing of transmitting the obtained image data to the slave apparatus (a step S50). This is the end of the processing executed by the relay apparatus 104 according to the second embodiment.

The following will describe processing executed by the slave apparatus 101 according to the second embodiment. FIG. 17 is a flow chart showing in detail the processing executed by the slave apparatus 101. As shown in FIG. 17, a CPU 31 of the slave apparatus 101 executes processing of receiving the broadcast signal transmitted from the relay apparatus 104 in the processing at the step S41 (a step S61).

Next, the CPU 31 transmits the connection request to the relay apparatus 104 by means of local communication (a step S62). Subsequently, the CPU 31 executes processing of establishing connection to the relay apparatus 104 by means of local communication (a step S63).

After establishing the connection to the relay apparatus 104, the CPU 31 of the slave apparatus 101 executes processing of receiving the decoration image data transmitted from the relay apparatus 104, and compositing the decoration image data and a camera image (steps S14 to S20). The processing at the steps S14 to S20 is the same as that at the steps S14 to S20 described with reference to FIG. 11 in the first embodiment except for a fact that a communication partner is the relay apparatus 104. Thus, detailed description thereof will be omitted.

As described above, in the second embodiment, the slave apparatus 101 can obtain a decoration image which is different depending on a position where the slave apparatus 101 is present without performing communication directly with the server 103.

It is noted that the relay apparatus 104 may be, for example, a stationery game apparatus which is capable of performing communication with the server 103 via an AP and the Internet. It may be configured that the above local communication can be performed between the stationery game apparatus and the game apparatus 101.

The processing of connecting to the game apparatus 101 and the processing of connecting to the server 103 are not limited to be executed in a series of processing as shown in the above flow chart, and may be executed in parallel independently of each other. Further, the relay apparatus 104 may obtain in advance a decoration image from a server. In other words, the processing at C21 to C23 described with reference to FIG. 15 is not limited to be executed together when the slave apparatus 101 performs imaging processing, and may be executed in advance. In other words, the slave apparatus 101 may connect to the relay apparatus 104 which has already downloaded a decoration image from the server 103 by means of local communication.

### Third Embodiment

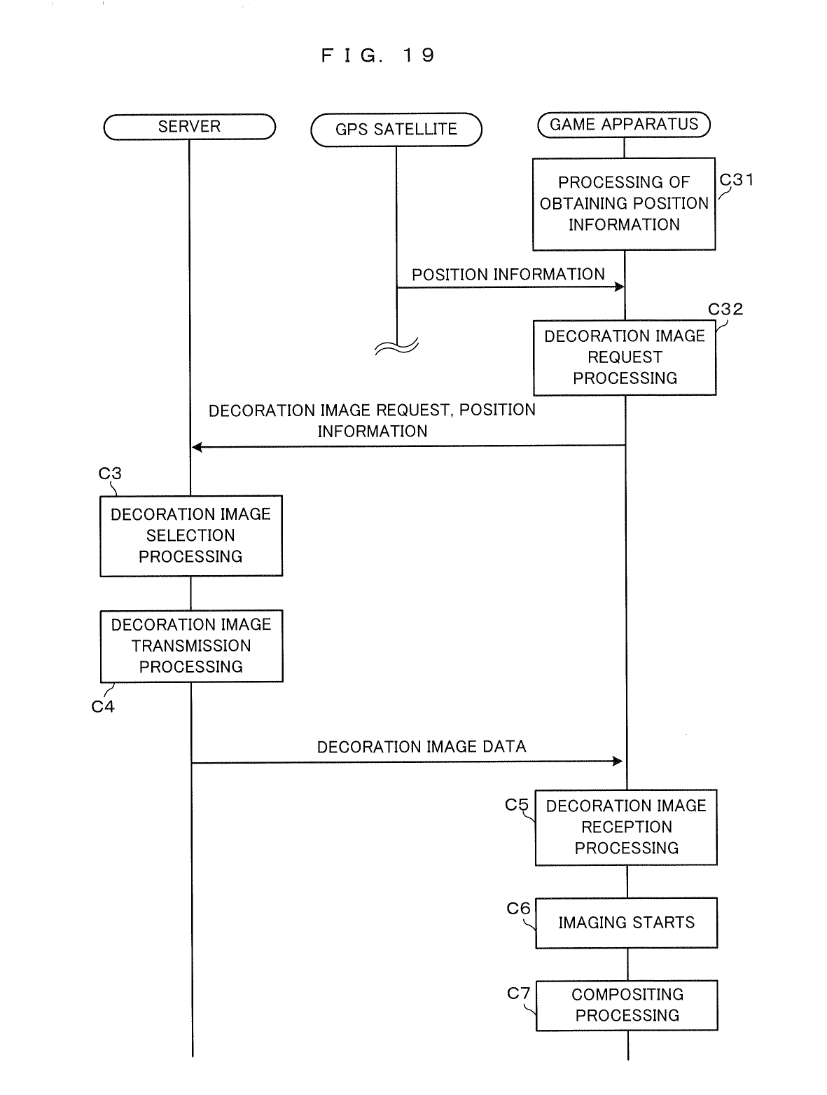

The following will describe a third embodiment with reference to FIGS. 18 to 20. In the above first embodiment, the server 103 selects a decoration image based on the identification information (SSID) of the AP 102 which is transmitted from the game apparatus 101. On the other hand, in the third embodiment, position information indicated by latitude, longitude, and the like is used instead of the identification information of the AP 102. More specifically, in the server 103, a table in which position information such as latitude, longitude, and the like is registered instead of the identification information 6251 of the AP-image correspondence table 625 described above with reference to FIG. 9 is prepared (see FIG. 18). Meanwhile, for example, a game apparatus 101 is fitted or provided with a GPS receiver. The game apparatus 101 obtains information indicative of latitude and longitude of a position where the game apparatus 101 is present using the GPS. The game apparatus 101 transmits the position information to a server 103. The server 103 selects and loads decoration image data based on the position information, and transmits the decoration image data to the game apparatus 101.

It is noted that a configuration of the server 103 according to the third embodiment is the same as that according to the above first embodiment except for a fact that the table as shown in FIG. 18 is stored, and thus the same components are designated by the same reference characters and detailed description thereof will be omitted. Although not shown in the drawings, the game apparatus 101 is fitted or provided with a predetermined GPS receiver. Except for this fact, a configuration of the game apparatus 101 is the same as that according to the above first embodiment, and thus the same components are designated by the same reference characters and detailed description thereof will be omitted.

FIG. 19 is a view for explaining an outline of processing according to the third embodiment. As shown in FIG. 19, the game apparatus 101 executes processing of obtaining position information (C31). In the present embodiment, the position information is obtained using the GPS.

Next, the game apparatus 101 establishes connection to a predetermined server via a predetermined AP (not shown in FIG. 19) and the Internet, and then executes processing of requesting data of a decoration image from the server (C23). At this time, the position information obtained using the GPS is transmitted to the server.

The server 103 selects decoration image data based on the position information (C3), and executes processing of transmitting the decoration image data to the game apparatus 101 (C4). After that, the game apparatus 101 executes processing which is the same as that at C5 to C7 described above with reference to FIG. 3.

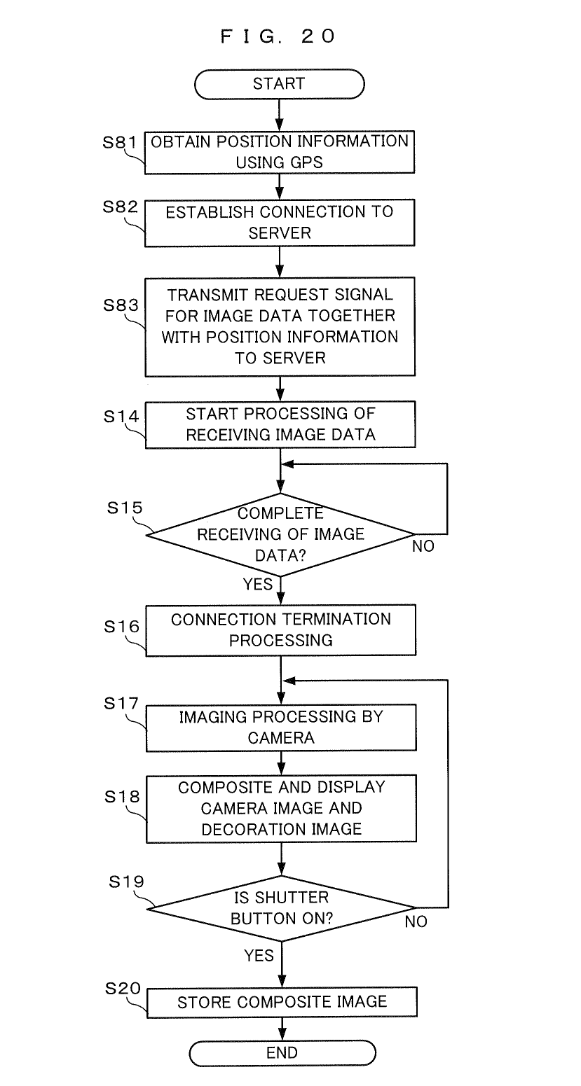

The following will describe in detail the processing according to the third embodiment with reference to FIG. 20. Processing executed by the server 103 is the same as that according to the above first embodiment except for a fact that the above position information is used instead of identification information of an AP, and thus detailed description thereof will be omitted.

FIG. 20 is a flow chart showing in detail processing of the game apparatus 101 according to the third embodiment. In FIG. 20, processing at steps S14 to S20 is the same as the processing at the steps S14 to S20 described with reference to FIG. 11 in the above first embodiment, and thus detailed description thereof will be omitted.

As shown in FIG. 20, the CPU 31 obtains position information of a position where the game apparatus 101 is present using the GPS (a step S81). Next, the CPU 31 establishes connection to the server 103 via a predetermined AP (a step S82). Subsequently, the CPU 31 transmits the position information obtained at the step S81 together with the above image data transmission request to the server 103 (a step S83). Accordingly, a CPU 61 of the server 103 selects and loads decoration image data by executing processing which is the same as the processing at the above step S34 based on the position information, and transmits the decoration image data to the game apparatus 101.

Then, the CPU 31 executes processing which is the same as that at the step S14 and thereafter as described with reference to FIG. 11 in the first embodiment. This is the end of the processing executed by the game apparatus 101 according to the third embodiment.

As described above, in the third embodiment, by using position information, the game apparatus 101 can obtain a decoration image which is different depending on a position where the game apparatus 101 is present, and can take a composite photograph including the decoration image.

It is noted that although the position information is obtained using the GPS in the third embodiment, the present invention is not limited thereto, and processing of detecting a wireless LAN access point which is present in the vicinity of the game apparatus 101 may be executed for identifying a current position of the game apparatus 101 based on its radio wave intensity.

Further, the above position information can be similarly used in the above second embodiment. In other words, the relay apparatus 104 and the slave apparatus 101 each obtain position information thereof using a GPS, and the like. When the relay apparatus 104 obtains the position information thereof, the position information may be transmitted to the server 103 instead of the identification information of the AP 102. When the slave apparatus 101 obtains the position information thereof, the slave apparatus 101 transmits the position information to the relay apparatus 104 by means of local communication. Then, the relay apparatus 104 transmits to the server 103 the position information transmitted from the slave apparatus 101.

### Fourth Embodiment

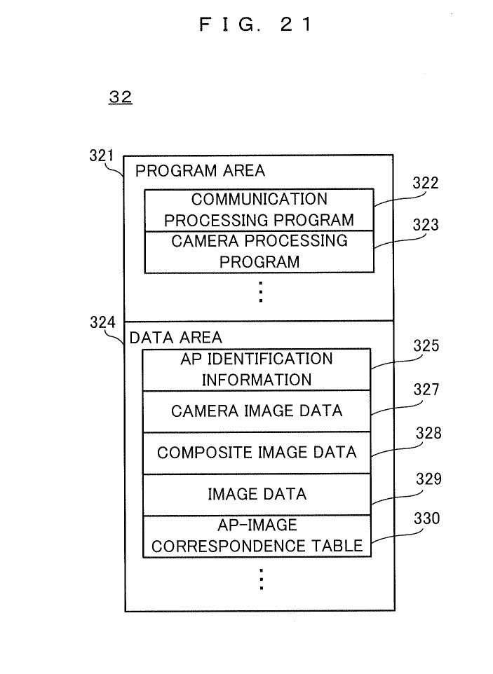

The following will describe a fourth embodiment with reference to FIGS. 21 to 23. In the above first embodiment, the AP-image correspondence table 625 and the image data 624 are stored in the server 103, and the game apparatus 101 obtains data (the image content 6242) of the decoration image from the server 103. On the other hand, in the fourth embodiment, data corresponding to the image data 624 and the AP-image correspondence table 625 are stored in a game apparatus 101. In other words, the game apparatus 101 executes processing which is the same as the processing in the above first embodiment until obtaining a SSID of a predetermined AP, but does not perform communication with a server via the AP, and executes processing of loading data of a decoration image from the image data 624 and the AP-image correspondence table 625, which are stored in the game apparatus 101, based on the SSID.

It is noted that a configuration of the game apparatus 101 according to the fourth embodiment is the same as that described above with reference to FIGS. 5 and 6 in the first embodiment, and thus the same components are designated by the same reference characters and detailed description thereof will be omitted.

FIG. 21 is a view showing a memory map of a main memory 32 of the game apparatus 101 according to the fourth embodiment. As shown in FIG. 21, the main memory 32 includes a program area 321 and a data area 324. In FIG. 21, the same data as those shown in the memory map in FIG. 10 in the above first embodiment are designated by the same reference characters.

As shown in FIG. 21, in the data area 324, the decoration image data 326 which is included in the data area 324 of the game apparatus 101 according to the above first embodiment is removed, and image data 329 and an AP-image correspondence table 330 are added. The image data 329 and the AP-image correspondence table 330 have the same contents as those of the image data 624 and the AP-image correspondence table 625 which are stored in the server 103 in the first embodiment (see FIGS. 8 and 9). Thus, detailed description of the contents and configurations of the image data 329 and the AP-image correspondence table 330 will be omitted.

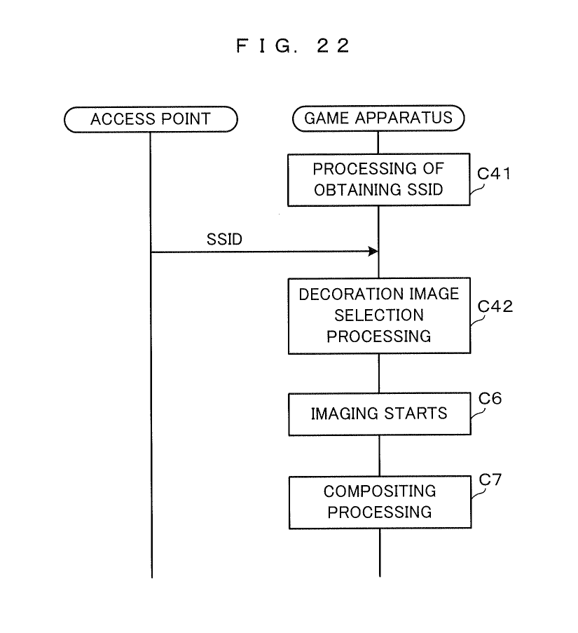

The following will describe an outline of processing according to the fourth embodiment with reference to FIG. 22. As shown in FIG. 22, the game apparatus 101 executes processing of obtaining an SSID from a predetermined AP (C41). Next, the game apparatus 101 refers to the AP-image correspondence table 330 and the image data 329 which are stored in the main memory 32, and selects decoration image data based on the obtained SSID (C42). Then, the game apparatus 101 starts imaging processing by the outer camera 25 (or the inner camera 23) (C6), and executes compositing processing of compositing the selected decoration image and an image taken by the outer camera 25 (or the inner camera 23) (C7).

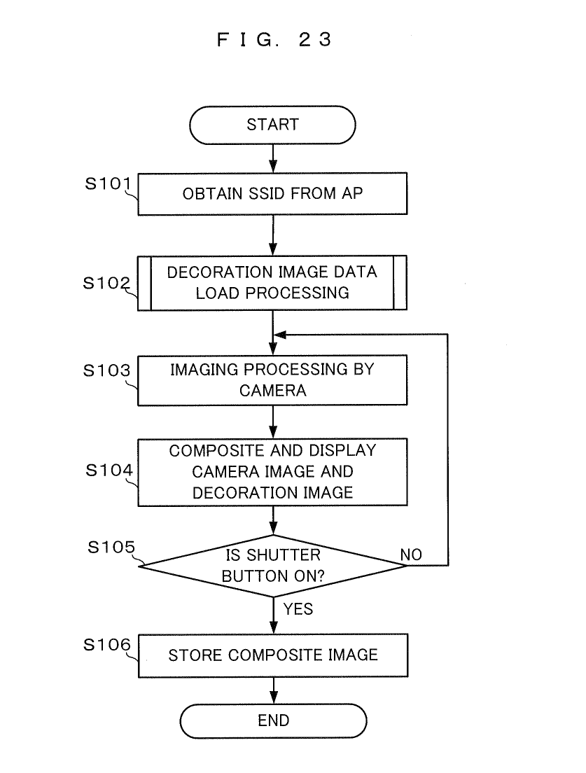

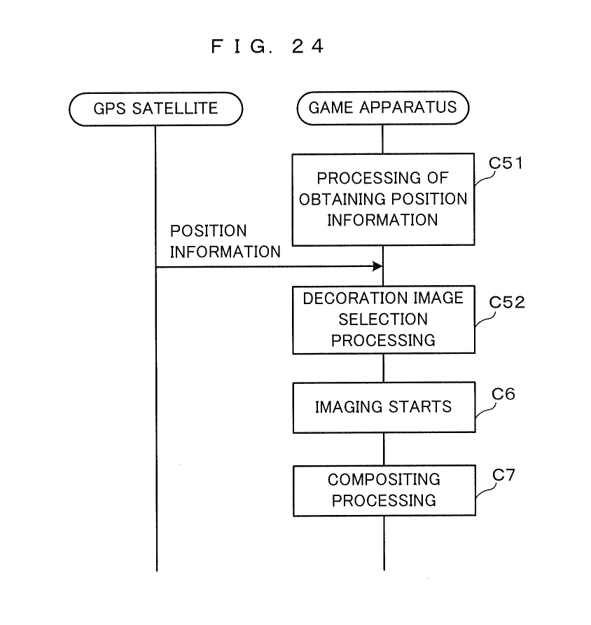

The following will describe in detail processing of the game apparatus 101 according to the fourth embodiment with reference to FIG. 23. As shown in FIG. 23, the CPU 31 executes processing of obtaining an SSID broadcasted from a predetermined AP (a step S101).

Next, the CPU 31 executes processing of loading decoration image data based on the SSID obtained at the step S101 (a step S102). This processing is the same as the processing at the step S34 described above with reference to FIG. 13 except for a fact that the image data 329 and the AP-image correspondence table 330 which are stored in the main memory 32 are used. Thus, detailed description thereof will be omitted.

Next, the CPU 31 executes imaging processing by the outer camera 25 (or the inner camera 23) (a step S103). In other words, the CPU 31 starts to take an image captured by the outer camera 25 (or the inner camera 23), and stores the image as camera image data 327 in the main memory 32. Subsequently, the CPU 31 composites data of the decoration image loaded at the step S102 and the camera image data 327 to generate composite image data 328. Then, the CPU 31 displays a composite image on the lower LCD 12 (a step S104). Thus, the user can visually confirm what composite image can be taken.

Next, the CPU 31 determines whether or not a shutter button has been pressed (a step S105). As a result of the determination, when the CPU 31 determines that the shutter button has not been pressed (NO at the step S105), the CPU 31 returns to the processing at the step S103, and repeats the processing of displaying the composite image indicated by the composite image data 328 on the lower LCD 12.

On the other hand, as the result of the determination at the step S105, when the CPU 31 determines that the shutter button has been pressed (YES at the step S105), the CPU 31 executes processing of storing the composite image data 328 in the memory card 28 (a step S106). This is the end of the processing executed by the game apparatus 101 according to the fourth embodiment.

As described above, in the fourth embodiment, the game apparatus 101 can take a composite photograph including a decoration image which depends on a position where the game apparatus 101 is present without performing communication with the server 103.

It is noted that the image data 329 and the AP-image correspondence table 330 may be configured such that addition, update, and deletion are possible via a network for the contents therein. For example, the game apparatus 101 accesses a predetermined server using a wireless communication module 37, and downloads image data 329 and an AP-image correspondence table 330 to be stored in the memory card 28. When performing the above imaging processing, the downloaded image data 329 and the downloaded AP-image correspondence table 330 may be loaded in the main memory 32, and the above processing may be executed using the image data 329 and the AP-image correspondence table 330 after the download. Alternatively, only data (difference data) regarding change may be downloaded, and the image data 329 and the AP-image correspondence table 330 may be updated based on the difference data. Still alternatively, the game apparatus 101 may obtain the image data 329 and the AP-image correspondence table 330 from another game apparatus 101 using the wireless communication module 37, not from a predetermined server. Further, the latest image data 329 and the latest AP-image correspondence table 330 may be stored in a predetermined storage medium such as the memory card 28 and the memory card 29, and may be loaded into the game apparatus 101 therefrom.

### Fifth Embodiment

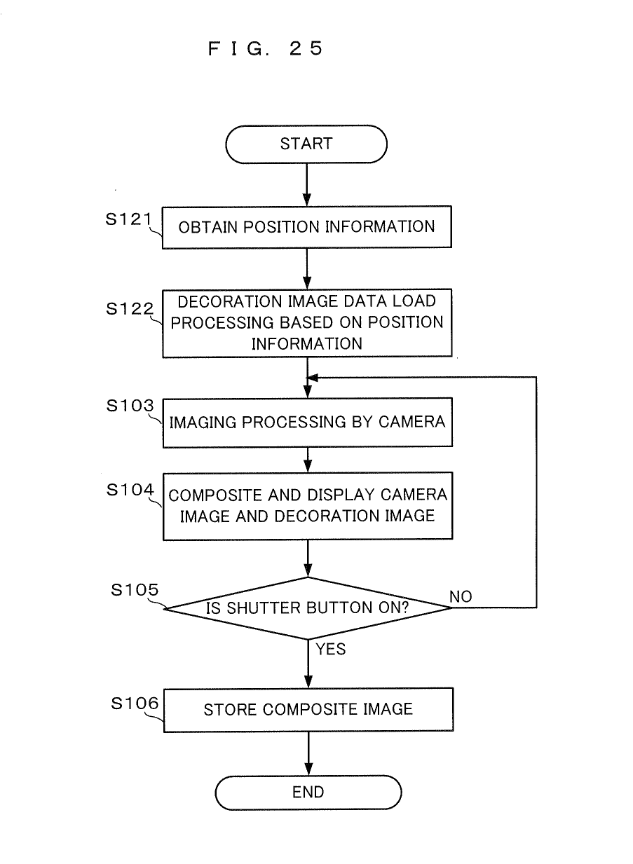

The following will describe a fifth embodiment with reference to FIGS. 24 and 25. In the fifth embodiment, position information obtained using a GPS, and the like is used instead of identification information of an AP which is used for selecting a decoration image in the above fourth embodiment. Thus, in the fifth embodiment, instead of the AP-image correspondence table 330 in the main memory 32 of the game apparatus 101, a correspondence table in which position information is registered as shown in FIG. 18 is stored. A game apparatus 101 according to the fifth embodiment is fitted or provided with a predetermined GPS. Except for the fact, a configuration of the game apparatus 101 according to the fifth embodiment is the same as that described above with reference to FIGS. 5 and 6 in the first embodiment, and thus the same components are designated by the same reference characters and detailed description will be omitted.

The following will describe an outline of processing according to the fifth embodiment with reference to FIG. 24. First, the game apparatus 101 executes processing of obtaining position information using the GPS (C51). Next, the game apparatus 101 executes processing of selecting decoration image data based on the position information (C52). Then, the game apparatus 101 starts imaging processing by the outer camera 25 (or the inner camera 23) similarly as in the above first embodiment (C6), and executes compositing processing of compositing a selected decoration image and a camera image (C7).

The following will describe in detail processing of the game apparatus 101 according to the fifth embodiment with reference to FIG. 25. In FIG. 25, processing at steps S103 to S106 is the same as the processing at the steps S103 to S106 described above with reference to FIG. 23 in the fourth embodiment, and thus detailed description thereof will be omitted.

As shown in FIG. 25, first, the CPU 31 obtains position information of a position where the game apparatus 101 is present using the GPS (a step S121).

Next, the CPU 31 executes processing of selecting and loading a decoration image based on the position information obtained at the step S121 (a step S122). More specifically, the CPU 31 refers to the correspondence table (see FIG. 18) stored in the main memory 32, and loads image ID 6256 based on the position information obtained at the step S121. In other words, the CPU 31 executes decoration image data load processing as described above with reference to FIG. 13 using the position information instead of identification information.

After that, the CPU 31 executes imaging processing by the outer camera 25 (or the inner camera 23), and the above compositing processing (the steps S103 to S106). This is the end of the processing executed by the game apparatus 101 according to the fifth embodiment.

As described above, in the fifth embodiment, similarly as in the fourth embodiment, the game apparatus 101 can take a composite photograph including a decoration image which depends on a position where the game apparatus 101 is present without performing communication with the server 103.

In each of the above embodiments, when compositing a camera image and a decoration image obtained from the server 103, and the like, it may be possible to perform editing of the decoration image. For example, in a state where a composite image is displayed on the lower LCD 12, a touch panel input is accepted from the user. Then, in accordance with its input content (a drag operation of the decoration image, and the like), the decoration image may be moved, enlarged, reduced in size, or rotated. Alternatively, before executing processing of displaying a composite image on the lower LCD 12, only a decoration image may be displayed on the lower LCD 12, and it may be possible to perform the above editing. Then, a decoration image after the editing and a camera image may be composited and displayed on the lower LCD 12. Thus, it is possible for the user to change a decoration image depending on a photographing situation, and enjoyment of photographing can be enhanced more.

In each of the above embodiments, one SSID (or position information) is caused to correspond to one decoration image, but one SSID may be caused to correspond to a plurality of decoration images. In other words, the CPU 61 of the server 103 loads a plurality of decoration images in the processing at the step S34 in FIG. 12, and transmits the plurality of decoration images to the game apparatus 101 in the processing at the step S35. The CPU 31 of the game apparatus 101 receives data of the plurality of decoration images in the processing at the steps S14 and S15 as described with reference to FIG. 11, and stores the data in the main memory 32. Then, the CPU 31 starts imaging by the outer camera 25 (or the inner camera 23) in the processing at the step S17, and displays a camera image on the lower LCD 12. In addition, the CPU 31 displays a selection screen of the plurality of decoration images on the upper LCD 22 for causing the user to select a desired decoration image. The CPU 31 composites a decoration image selected by the user and the camera image, and displays a composite image on the lower LCD 12.

Further, after a composite image is stored by pressing the shutter button, the decoration image data 326 may be deleted. In other words, the CPU 31 may be caused to execute processing of deleting the decoration image data 326 after the processing at the step S20. Or, the CPU 31 may be caused to execute processing of deleting the decoration image data 326 when the power of the game apparatus 101 is turned off. Thus, a specific decoration image can be obtained at a limited place and on a limited date at a limited time, thereby increasing the value of the decoration image and providing greater enjoyment of photographing to the user.

Further, as an example of the identification information, the SSID of the AP 102, and the like are used, but in addition, information regarding hardware of a game apparatus which accesses the server 103 may be used. For example, when a plurality of types of game apparatuses having different screen resolution and different numbers of display colors access the server 103, decoration images which are different depending on the screen resolution and the numbers of display colors of the game apparatuses may be transmitted from the server 103.

Further, regarding the above access date and time, in the first, second, and third embodiments, the server 103 obtains access date and time. However, the present embodiments are not limited thereto, and the game apparatus 101 (the relay apparatus 104 and the slave apparatus 101 in the second embodiment) may obtain information indicative of access date and time, and may transmit the information to the server 103. For example, in the processing at the step S13, the CPU 31 calculates current date and time based on the output of the RTC 29. Then, the CPU 31 may transmit information indicative of the date and time together with the SSID to the server 103. In the case of the second embodiment, the slave apparatus 101 calculates date and time, and transmits information indicative of the date and time to the relay apparatus 104 by means of local communication, and the relay apparatus 104 transmits the information to the server 103. Thus, a decoration image which is different depending on a region (time zone) where a terminal is present can be transmitted from the server 103 to the game apparatus 101.

Further, each of the above embodiments has described the case where the camera takes a still image, but the present embodiments are applicable to even the case where a camera is capable of taking a moving image.

Further, regarding the above AP, each of the above embodiments has described the case where identification information of an AP is registered in advance in the AP-image correspondence table 625 in the server 103. However, the present embodiments are not limited thereto, and, for example, it may be possible for the user to newly register identification information of an AP placed in user's house in the server 103. In this case, a decoration image which is created by the user may be uploaded and stored in the server 103 so as to be associated with the identification information of the AP in the user's house.

Further, each of the above embodiments has described the case where communication is performed via the AP 102 which is a wireless LAN relay apparatus as an example of a wireless communication relay point. Alternatively, a radio relay station such as a base station for mobile phones may be used as a wireless communication relay point. For example, instead of the game apparatus 101, a mobile phone having a camera function may be used and may access the server 103 via a mobile telephone network to obtain the above decoration image. Then, a decoration image which is different depending on identification information of a base station to which the mobile phone connects when performing communication with the server 103 may be transmitted from the server 103 to the mobile phone.

Further, in each of the above embodiments, the game apparatus 101 accesses the server 103 to obtain a decoration image before starting imaging processing by the camera. However, the present embodiments are not limited thereto, and the game apparatus 101 may access the server 103 to obtain a decoration image after starting imaging by the camera, and then perform compositing. For example, in the processing described above with reference to FIG. 11, the processing at the steps S11 to S16 may be executed subsequent to the step S17.

While the embodiments presented herein have been described in detail, the foregoing description is in all aspects illustrative and not restrictive. It is understood that numerous other modifications and variations can be devised without departing from the scope of the embodiments.

What is claimed is:

1. An imaging apparatus for compositing a taken image taken by an imaging unit and a decoration image stored in storage locations to generate a composite image, the imaging apparatus comprising:
a position information obtaining unit for obtaining position information indicative of a position where the imaging apparatus is present;
a hardware information obtaining unit for obtaining hardware-related information regarding the imaging apparatus itself;
a decoration image selection unit for selecting a predetermined decoration image from the storage locations based on the position information and the hardware-related information; and
a composite image generation unit for compositing the predetermined decoration image selected by the decoration image selection unit and the taken image to generate a composite image.

2. The imaging apparatus according to claim 1, wherein
the hardware-related information is information relating to at least either of a resolution of a screen of the imaging apparatus, and the number of display colors of the screen.

3. The imaging apparatus according to claim 1, wherein
the position information obtaining unit includes a position information measuring unit for measuring position information of the imaging apparatus itself, and
the decoration image selection unit selects a predetermined decoration image from the storage locations based on the position information measured by the position information measuring unit and the hardware-related information.

4. The imaging apparatus according to claim 1, further comprising a date and time information obtaining unit for obtaining date and time information regarding a current date and time, wherein
the decoration image selection unit selects a predetermined decoration image from the storage locations based on the position information, the hardware-related information, and the date and time information obtained by the date and time information obtaining unit.

5. The imaging apparatus according to claim 4, wherein
a plurality of decoration images for which valid periods are set and a plurality of decoration images for which no valid periods are set are stored in the storage locations, and
when the date and time represented by the date and time information is included in the valid period set for a decoration image selected based on the position information and the hardware-related information, the decoration image selection unit selects the decoration image, whereas when the date and time is not included in the valid period, the decoration image selection unit selects a predetermined decoration image from among the decoration images for which no valid periods are set.

6. The imaging apparatus according to claim 1, further comprising a decoration image update unit for adding, updating, or deleting the decoration image via at least one of a predetermined communication line and an external storage unit which is connectable to the imaging apparatus.

7. The imaging apparatus according to claim 1, further comprising a display for displaying at least one of the taken image, the decoration image, and the composite image.

8. The imaging apparatus according to claim 7, further comprising:
an operation input unit for accepting a predetermined operation input; and
a decoration image editing unit for performing editing of the decoration image displayed on the display or a decoration image on the composite image based on the operation input accepted by the operation input unit.

9. The imaging apparatus according to claim 8, wherein
the operation input unit is a pointing device, and
the decoration image editing unit performs editing by means of the pointing device.

10. The imaging apparatus according to claim 9, wherein
the pointing device is a touch panel,
the touch panel is located on the display so as to cover the display, and
the decoration image editing unit performs editing of the decoration image displayed on the display or a decoration image on the composite image based on an input by a user with respect to the touch panel.

11. The imaging apparatus according to claim 1, wherein
the decoration image selection unit selects a plurality of decoration images, and
the imaging apparatus further comprises a user selection unit for causing a user to select a desired image from among the plurality of decoration images selected by the decoration image selection unit.

12. The imaging apparatus according to claim 1, further comprising a wireless communication unit for performing local communication directly with another imaging apparatus, wherein
the decoration image selection unit obtains, via the local communication, the decoration image selected based on the position information obtained by the another imaging apparatus, and the hardware-related information.

13. The imaging apparatus according to claim 1, further comprising:
a custom decoration image generation unit for generating a predetermined decoration image based on a user operation; and
a custom decoration image transmission unit for transmitting the decoration image generated by the custom decoration image generation unit, in association with the position information.

14. An imaging system comprising a server for storing a decoration image, and an imaging apparatus for compositing a taken image taken by an imaging unit and a predetermined decoration image to generate a composite image, the server being connected to the imaging apparatus via a network,
the imaging apparatus comprising:
a position information obtaining unit for obtaining position information indicative of a position where the game apparatus is present;
a hardware information obtaining unit for obtaining hardware-related information regarding the imaging apparatus itself;
an information transmission unit for transmitting, to the server, the position information and the hardware-related information;
a decoration image reception unit for receiving a predetermined decoration image from the server; and
a composite image generation unit for compositing the predetermined decoration image received by the decoration image reception unit and the taken image to generate a composite image,
the server comprising:
storage locations in which a plurality of decoration images associated with a plurality of pieces of hardware-related information, respectively, are stored;
an information reception unit for receiving the position information and the hardware-related information from the imaging apparatus;
a decoration image selection unit for selecting a predetermined decoration image from the storage locations of the server, based on the position information and the hardware-related information received by the information reception unit; and
a decoration image transmission unit for transmitting, to the imaging apparatus, the predetermined decoration image selected by the decoration image selection unit.

15. The imaging system according to claim 14, wherein
the hardware-related information is information regarding at least either of a resolution of a screen of the imaging apparatus, and the number of display colors of the screen.

16. The imaging system according to claim 14, wherein
the position information obtaining unit includes a position information measuring unit for measuring position information of the imaging apparatus, and
the information transmission unit transmits the position information measured by the position information measuring unit.

17. The imaging system according to claim 14, wherein
the imaging apparatus further includes:
a date and time information obtaining unit for obtaining date and time information regarding a current date and time; and
a date and time information transmission unit for transmitting the date and time information to the server,
the server further includes a date and time information reception unit for receiving the date and time information from the imaging apparatus, and
the decoration image selection unit selects a predetermined decoration image from the storage locations of the server, based on the position information, the hardware-related information, and the date and time information obtained by the date and time information reception unit.

18. An imaging system according to claim 17, wherein
a plurality of decoration images for which valid periods are set and a plurality of decoration images for which no valid periods are set are stored in the storage locations, and
when the date and time represented by the date and time information is included in the valid period set on a decoration image selected based on the position information and the hardware-related information, the decoration image selection unit selects the decoration image, whereas when the date and time is not included in the valid period, the decoration image selection unit selects a predetermined decoration image from among the decoration images on which no valid periods are set.

19. The imaging system according to claim 14, wherein
the imaging apparatus further includes:
a custom decoration image generation unit for generating a predetermined decoration image based on a user operation; and
a custom decoration image transmission unit for transmitting, to the server, the decoration image generated by the custom decoration image generation unit, in association with the position information, and
the server further includes:
a custom decoration image reception unit for receiving the decoration image transmitted by the custom decoration image transmission unit; and
a custom decoration image storage unit for storing, in the storage locations, the decoration image received by the custom decoration image reception unit, in association with the position information.

20. An imaging control method for controlling an imaging apparatus which composites a taken image taken by an imaging unit and a decoration image stored in storage locations to generate a composite image, the method comprising:
obtaining position information indicative of a position where the imaging apparatus is present;
obtaining hardware-related information regarding the imaging apparatus itself;
selecting a predetermined decoration image from the storage locations based on the position information and the hardware-related information; and
compositing the selected predetermined decoration image and the taken image to generate a composite image.

21. A non-transitory storage medium having stored thereon an imaging program executed by a computer of an imaging apparatus which composites a taken image taken by an imaging unit and a decoration image stored in storage locations to generate a composite image, the imaging program causing the computer to perform at least:
obtaining position information indicative of a position where the imaging apparatus is present;
obtaining hardware-related information regarding the imaging apparatus itself;
selecting a predetermined decoration image from the storage locations based on the position information and the hardware-related information; and
compositing the selected predetermined decoration image and the taken image to generate a composite image.

22. The imaging control method according to claim 20, wherein
the hardware-related information is information regarding at least either of a resolution of a screen of the imaging apparatus, and the number of display colors of the screen.

23. The non-transitory storage medium according to claim 21, wherein
the hardware-related information is information regarding at least either of a resolution of a screen of the imaging apparatus, and the number of display colors of the screen.

24. The imaging control method according to claim 20, further comprising
obtaining date and time information regarding a current date and time, wherein
a predetermined decoration image is selected from the storage locations based on the position information, the hardware-related information, and the obtained date and time information.

25. The non-transitory storage medium according to claim 21, wherein the imaging program causes the computer to further perform
obtaining date and time information regarding a current date and time, wherein
a predetermined decoration image is selected from the storage locations based on the position information, the hardware-related information, and the obtained date and time information.
